(19) United States
(12) Patent Application Publication
(10) Pub. No.: US 2026/0231246 A1
(43) Pub. Date: Aug. 6, 2026

(54) SYSTEMS, METHODS, AND APPARATUSES FOR DETERMINING DEVICES IN AN AREA

(71) Applicant: Comcast Cable Communications, LLC, Philadelphia, PA (US)

(72) Inventor: Suresh Parathi, Philadelphia, PA (US)

(21) Appl. No.: 19/042,425

(22) Filed: Jan. 31, 2025

(51) Int. Cl. H04W 76/10; H04W 72/0453

(52) U.S. Cl. CPC H04W 76/10; H04W 72/0453

(57) ABSTRACT

Methods, systems, and apparatuses are provided for communicating operating channel information on a reporting channel of a wireless frequency band. Computing devices, such as network devices (e.g., access points, routers, or gateways) may desire to determine operating information about other network devices and other devices in an area. These computing devices may also desire to determine information about other channels in the frequency band. The computing devices may synchronize the times or periods that each of the computing devices reports to and receives from other computing devices operating channel information. Each computing device may switch from its operating channel to a particular channel within the frequency band, the reporting channel, to report to and receive from the other computing devices the operating channel information during each reporting period.

### BACKGROUND

Computing devices, such as network devices (e.g., access points, routers, or gateways), communicate with other devices in their network on an operating channel of a frequency band. These network devices may also be required to scan other channels to determine information about other network devices within communication range of the network device. Referred to as off-channel scanning. The network device may change from its operating channel, where it communicates with other devices in its network, to each other channel in the frequency band to listen on those other channels and receive signals in order to determine other network devices within communication range of the network device. Switching from its operating channel to listen on each other channel to determine what other network devices reduces the time the network device can spend on its operating channel communicating with devices on its network and thus reduces the efficiency of the network device to manage its own network.

### SUMMARY

It is to be understood that both the following general description and the following detailed description are exemplary and explanatory only and are not restrictive. Methods and systems for determining frequency separation in a network are described.

Methods, systems, and apparatuses are provided for communicating operating channel information on a reporting channel of a wireless frequency band. Computing devices, such as network devices (e.g., access points, routers, or gateways) may desire to determine operating information about other network devices and other devices in an area. These computing devices may also desire to determine information about other channels in the frequency band. The computing devices may determine times to report to and receive from other computing devices the operating information and the channel information. The computing device may switch to a particular channel within the frequency band during a particular time period to report to and receive from the other computing devices the operating information and the channel information.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system;

FIG. 2 show an example channel layout for a frequency band;

FIG. 3 shows an example system;

FIG. 4 shows an example method;

FIG. 5 shows a flowchart of an example method;

FIG. 6 shows a flowchart of an example method;

FIG. 7 shows a flowchart of an example method;

FIG. 8 shows a flowchart of an example method;

FIG. 9 shows a flowchart of an example method;

FIG. 10 shows a flowchart of an example method;

FIG. 11 shows a flowchart of an example method;

FIG. 12 shows a flowchart of an example method;

FIG. 13 shows a flowchart of an example method;

FIG. 14 shows a flowchart of an example method;

FIG. 15 shows a flowchart of an example method; and

FIG. 16 shows an example system.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

In an effort to reduce the number of channels a network device must monitor for off-channel scans, in certain wireless frequency bands a plurality of the channels have been designated as preferred scanning channels. For example, in the 6 gigahertz frequency band, beginning with the lowest frequency 20-megahertz channel, every fourth 20-megahertz channel is designated as a preferred scanning channel. Thus, when doing off channel scanning, the network device is expected to switch from its operating channel to each of the preferred scanning channels to listen and determine if other access points are operating on any of those preferred scanning channels.

However, for each frequency band, there can still be a large number of preferred scanning channels that a network device must spend time listening on to detect these other access points. For example, in the 6 gigahertz frequency band, there are fifteen preferred scanning channels for the frequency band. If the network device is already operating on a channel that includes the frequency range of one of the preferred scanning channels, that still leaves fourteen preferred scanning channels that the network device must listen in on during off channel scanning. The time required for the network device to leave its operating channel to conduct off-channel scanning on a plurality of preferred scanning channels significantly reduces the operating efficiency of the network device because the amount of time the network device must listen on the preferred scanning channels for other network devices significantly reduces the time the network device can spend handling traffic on its operating channel. Providing a single channel that all network devices go to, to reporting channel information would reduce the time the network device is off of its operating channel and would improve the efficiency of the network device to manage its network on its operating channel.

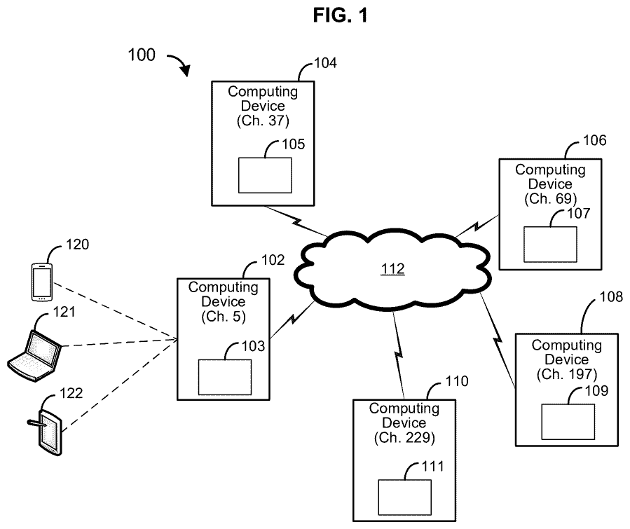

FIG. 1 shows a system 100 for communicating operating channel information on a reporting channel (e.g., a common reporting channel). Although only certain devices and/or components are shown, the system 100 may comprise a variety of other devices and/or components that support a wide variety of network and/or communication functions, operations, protocols, content, services, and/or the like. For example, the system 100 may support and/or facilitate a Domain Name System (DNS), Hypertext Transfer Protocol (HTTP), Hypertext Transfer Protocol Secure (HTTPS), DNS over HTTPS (DoH), Transport Layer Security (TLS) protocol, DNS over TLS (DoT), encrypted DNS, and/or the like.

The system 100 may comprise a network. The network may comprise a packet-switched network (e.g., an Internet protocol-based network), a non-packet switched network (e.g., quadrature amplitude modulation based network), and/or the like. The network may comprise network adapters, switches, routers, modems, and the like connected through wireless links (e.g., radiofrequency, satellite, etc.) and/or physical links (e.g., fiber optic cable, coaxial cable, Ethernet cable, or a combination thereof). The network may comprise public networks, private networks, wide area networks (e.g., Internet), local area networks, and/or the like. The network may comprise a content access network, content distribution network, and/or the like. The network may be configured to provide communication from telephone, cellular, modem, and/or other electronic devices to and throughout the system 100. The network and/or devices in communication and/or associated with the network may provide, facilitate, and/or support one or more services, applications, and/or protocols, such as a DNS, HTTP, HTTPS, DoH, TLS protocol, DoT, encrypted DNS, and/or the like. The network may be configured to include one or more computing devices 102, 104, 106, 108, 110 and one or more devices 120-122, and/or any other device/component.

Each computing device 102, 104, 106, 108, 110 may be a computer and comprise a network device. For example, each computing device 102, 104, 106, 108, 110 may comprise an access point, gateway, or router. For example, each computing device 102, 104, 106, 108, 110 may be configured to operate in a simultaneous transmit and receive mode and allows the computing device 102, 104, 106, 108, 110 to simultaneously send communications to one device of the plurality of devices 120-122 and receive communications from another device of the plurality of devices 120-122. For example, each computing device 102, 104, 106, 108, 110 may be configured to operate and communication with its associated devices, such as devices 120-122 for computing device 102, via an operating channel of a frequency band. For example, each computing device 102, 104, 106, 108, 110 may be configured to periodically switch from its operating channel to a reporting channel on the frequency band or another frequency band. For example, each computing device 102, 104, 106, 108, 110 may be configured to send signals on the reporting channel indicating the operating channel associated with the respective computing device 102, 104, 106, 108, 110 and other information associated with the operating channel. For example, each computing device 102, 104, 106, 108, 110 may be configured to listen on the reporting channel for signals from other computing devices 102, 104, 106, 108, 110. These other signals may indicate the operating channel associated with those other respective computing devices and other information associated with those other operating channels. For example, each computing device may determine when to listen and when to send signals by using a mechanism called Clear Channel Assessment (CCA), where each computing device actively listens on the reporting channel before sending its signal, to ensure the reporting channel is clear, effectively following a listen before speaking approach to avoid signal collisions with other computing devices on the reporting channel. If the reporting channel is busy, the particular computing device waits for a short period before attempting to send its signal on the reporting channel again.

Each computing device 102, 104, 106, 108, 110 may comprise a session management module. The computing devices 102, 104, 106, 108, 110 may receive a request for a communication session and use the session management module to determine and/or generate a corresponding session token (and/or a session ID). A session token (and/or a session ID) may be determined/generated through a random unique string generating process, a hashing algorithm, and/or any other method/means. A session token (and/or a session ID) may be stored (e.g., in a communication management array table), for example, by the respective computing device 102, 104, 106, 108, 110 receiving the request in a local and/or remote storage 103, 105, 107, 109, 111 (e.g., a database) with associated information, such as a device identifier, user/client identifier, device type, a time interval (e.g., a time-to-live (TTL) value, etc.), a device profile, and/or the like. A session token (and/or a session ID) may be encrypted and/or decrypted in accordance with the protocols (e.g., TLS protocol, etc.) associated with the system 100.

Each computing device 102, 104, 106, 108, 110 may also comprise a clock and/or timer for monitoring requests for communication sessions and communications sessions (e.g., a communication session between one of the devices 120-122 and the respective computing device 102, 104, 106, 108, 110). A time interval associated with a request for a communication session may be determined, for example, by the respective computing device 102, 104, 106, 108, 110. The respective computing device 102, 104, 106, 108, 110, based on the nature of a request for a communication session, may determine and/or update a predetermined and/or default time interval and/or determine a time interval during which the one of the devices 120-122 may establish and/or re-establish the communication session using a session token.

The respective computing device 102, 104, 106, 108, 110 may respond to a request for a communication session from a device 120-122 with a session token (and/or a session ID) and an indication of a determined time interval for the session token. The session token may be, for example, encrypted and embedded within a response to the device 120-122 according to the protocol of the system 100, such as a TLS protocol or the like. The respective computing device 102, 104, 106, 108, 110 may then implement the clock/timer to monitor the time interval.

Each computing device 102, 104, 106, 108, 110 may also comprise or have access to local or remote storage 103, 105, 107, 109, 111. In addition to the information discussed above that each respective computing device 102, 104, 106, 108, 110 may store in its respective local or remote storage 103, 105, 107, 109, 111, each computing device 102, 104, 106, 108, 110 may also store information received from other computing devices 102, 104, 106, 108, 110 during reporting periods on the reporting channel. For example, this reporting information may include one or more of identifiers for other computing devices 102, 104, 106, 108, 110, a bandwidth utilization for the operating channel of other computing devices 102, 104, 106, 108, 110, a number of devices communicating on the operating channel of other computing devices 102, 104, 106, 108, 110, a signal-to-noise ratio for the operating channel of other computing devices 102, 104, 106, 108, 110, and/or an amount of interference on the operating channel associated with other computing devices 102, 104, 106, 108, 110.

The system 100 may further comprise a plurality of devices 120-122. While three devices 120-122 are shown in the system 100, this is for example purposes only and greater or fewer devices 120-122 may be included in the system 100 and communicating with at least one of the computing devices 102, 104, 106, 108, 110 via one or more communication sessions. For example, each device 120-122 may be any one of a mesh extender, subordinate device, augmented reality device, virtual reality device, a client device, a personal computer, computing station, workstation, portable computer, laptop computer, mobile phone, tablet computer, smartphone, smartwatch, activity tracker, smart apparel, smart accessory, a game system, an IoT device, a thermostat, a home appliance. Each device 120-122 may be associated with device identifier. The device identifier may be any identifier, token, character, string, or the like, for differentiating one device (e.g., device 120) of the plurality of devices 120-122 from another device (e.g., device 121) of the plurality of devices 120-122. The device identifier may comprise information relating to the device 120-122, such as a MAC address, a name, a manufacturer, a model or type of device, a service provider associated with the device, a state of the device, a locator, a label, and/or classifier. Other information may be represented by the device identifier.

For example, the device identifier may comprise an address element and a service element. The address element may comprise a network address (e.g., an IP address, etc.), a media access control (MAC) address, or the like. The address element may be used to establish a communication session between the particular device 120-122, a computing device 102, 104, 106, 108, 110, other devices and/or components of the system 100, and/or the like. The address element may be used as an identifier and/or locator of the particular device 120-122. The address element may be persistent for a particular network.

The service element may comprise an identification of a service provider associated with the particular device 120-122 and/or with the class, type, or group of types of the particular device 104-114. The class, type, or group of types of the device 120-122 may be related to a type of device, a group of device types, a device capability, a type of service being provided, and/or a level of service (e.g., business class, service tier, service package, etc.). The service element may comprise information associated with a communication service provider (e.g., Internet service provider) that is providing or enabling data flow such as communication services to the particular device 120-122. The service element may comprise information relating to a preferred service provider for one or more particular services relating to the device 120-122. The address element may be used to identify or retrieve data from the service element, or vice versa. The address element and/or the service element may be stored remotely from the particular device 120-122 and retrieved by one or more devices such as the particular device 120-122, and/or the computing device 102, 104, 106, 108, 110. Other information may be represented by the service element.

Each device 120-122 may comprise and/or be associated with a communication interface. The communication interface may enable a user to interact with the particular device 120-122, the computing device 102, 104, 106, 108, 110, and/or any other device/component of the system 100. The communication interface may comprise and/or be associated with software, hardware, and/or interfaces that may be used to provide communication between a user and one or more of the device 120-122, the computing device 102, 104, 106, 108, 110, and/or any other device/component of the system 100. The communication interface may be used to request or query various files from a local source and/or a remote source, such as the computing device 102, 104, 106, 108, 110, and/or the like.

Each device 120-122 may comprise a client module. The client module may be an application, such as a web application, a user-agent based application (e.g., a single-page, browser-based, application), a native application, a DNS client engine, a mobile application, and or the like that is implemented/run on and/or associated with the particular device 120-122. The client module may support and/or facilitate one or more services, applications, and/or protocols, such as a DNS, HTTP, HTTPS, DoH, TLS protocol, DoT, encrypted DNS, and/or the like. Each device 120-122 may, for example, via the client module, request a communication session with the computing device 102, 104, 106, 108, 110.

The computing devices 102, 104, 106, 108, 110 and devices 120-122 may communicate via a network 112. The network 112 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 112 via a variety of transmission paths along the data, power, communication, and/or content data transmission system, including wireless paths (e.g., satellite paths, Wi-Fi paths, cellular paths, etc.) and terrestrial paths (e.g., wired paths (e.g., coaxial cable or fiber-optic), a direct feed source via a direct line, etc.).

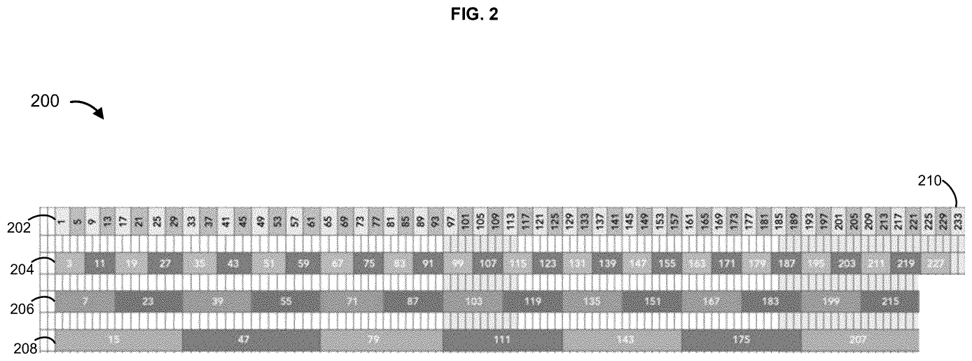

FIG. 2 show an example channel layout 200 for a frequency band for wireless communication by the computing devices 102, 104, 106, 108, 110 and/or the devices 120-122. For example, the frequency band may comprise a 6 gigahertz frequency band. For example, the frequency band may comprises a 5 gigahertz frequency band. For example, the frequency band may include 59 20-megahertz channels 202, 29 40-megahertz channels 204, 14 80 megahertz channels 206, and 7 160-megahertz channels 208. For example, the frequency band may include a reporting channel 210. For example, the reporting channel 210 may be any channel of the frequency band. For example, the reporting channel 210 may be the highest frequency channel or the lowest frequency channel of the frequency band. For example, the reporting channel 210 may comprise channel 233 of the 6 gigahertz frequency band. For example, the frequency range associated with channel 233 of the 6 gigahertz frequency band may be selected as the reporting channel because that 20 megahertz frequency range of channel 233 is not included in any of the 40-megahertz, 60-megahertz, or 80 megahertz channels of the 6 gigahertz frequency band. Since most devices operating on the 6 gigahertz frequency band will request channels having greater than a 20 megahertz frequency range as their operating channel for wireless communication, it less likely that any devices will be using channel 233 as an operating channel. Therefore, the likelihood of interference by or with devices operating and communicating on channel 233 as an operating channel is reduced and the likelihood that operating channels for devices will be different than the reporting channel will be increased.

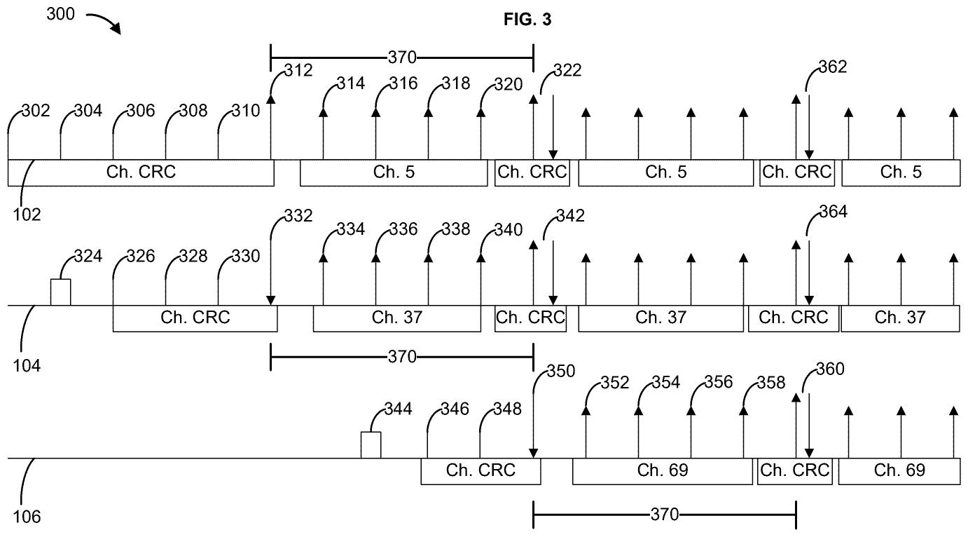

FIG. 3 shows an example system and procedure 300 for communicating operating channel information on a reporting channel. For example, the procedure may be completed by the computing devices 102, 104, 106, 108, 110 of FIG. 1. For example, each of the computing devices may be one or more of an access point, gateway, or router. Each of the computing devices may be configured to wirelessly communicate via one or more wireless communication protocols, such as WI-FI, Bluetooth, Zigbee or the like. The computing devices 102, 104, 106 of FIG. 3 may all be within an area where they are within wireless communication range of one another, such that each computing device may send signals that can be received by the other computing devices and can receive signals sent by the other computing devices. For example purposes only, the example of FIG. 3 will be described with reference to the computing devices being access points, however, this is for providing an example explanation of the procedure and is not intended to be limiting in any manner.

A first access point 102 may be turned on, reset, or brought into the area from another location. The first access point 102 may typically wirelessly communicate with other devices on an operating channel of a frequency band. For example, the frequency band may be the 5 gigahertz frequency band or the 6 gigahertz frequency band. For example, the operating channel for the first access point 102 may be any channel of the frequency band other than the reporting channel. The reporting channel may be any channel on the frequency band. For example, the reporting channel may be the highest frequency channel on the frequency band. For example, the reporting channel may be channel 233 of the 6 gigahertz frequency band.

The first access point 102 may switch or change channels that it is communicating on from the operating channel to the reporting channel. The first access point 102 may switch channels because the first access point 102 was just turned on, reset, moved into a new area, and/or does not know the reporting interval or reporting period for reporting information on the reporting channel. After switching to the reporting channel, the first access point 102 may switch to a listening mode and begin listening for other communications on the reporting channel. For example, the first access point 102 may listen on the reporting channel for a listening period 302-310. The listening period 302-310 may be any amount of time and/or may be a predetermined or pre-set amount of time that the first access point 102 listens on the reporting channel to hear if other computing devices (e.g., access points) are sending signals that indicate their respective operating channels. For example, the listening period 302-310 may be greater than the operating channel communication period for the first access point 102. For example, the listening period 302-310 may be greater than the reporting interval. For example, the listening period may be 50 milliseconds (ms). For example, the listening period may be any amount between and including 1 ms-5000 ms.

The first access point 102 may listen on the reporting channel for a first portion 302 of the listening period. The first access point 102 may determine that it did not hear or receive any signals from other access points. The first access point 102 may determine that the entirety of the listening period has not yet expired (e.g., the maximum listening time has not been reached). The first access point 102 may then listen on the reporting channel for a second portion 304 of the listening period. The first access point 102 may determine that it did not hear or receive any signals from other access points during the second portion 304 of the listening period. The first access point 102 may determine that the entirety of the listening period has not yet expired. The first access point 102 may then listen on the reporting channel for a third portion 306 of the listening period. The first access point 102 may determine that it did not hear or receive any signals from other access points during the third portion 306 of the listening period. The first access point 102 may determine that the entirety of the listening period has not yet expired. The first access point 102 may then listen on the reporting channel for a fourth portion 308 of the listening period. The first access point 102 may determine that it did not hear or receive any signals from other access points during the fourth portion 308 of the listening period. The first access point 102 may determine that the entirety of the listening period has not yet expired. The first access point 102 may then listen on the reporting channel for a fifth portion 310 of the listening period.

The first access point 102 may determine that it did not hear or receive any signals from other access points during the fifth portion 310 of the listening period. The first access point 102 may determine that the entirety of the listening period has expired or been completed. The first access point 102 may determine, based on not hearing signals from any other access points during the listening period 302-310 that there are no other access points reporting on the reporting channel. Based on not receiving any signals during the listening period 302-310, the first access point 102 may send or transmit a wireless signal 312 on the reporting channel. For example, the signal 312 may be a beacon signal. For example, the signal 312 may indicate or include the operating channel for the first access point. For example, the signal 312 may indicate or include one or more of an identifier for the first access point, a bandwidth utilization for the operating channel, a number of devices communicating on the operating channel, a signal-to-noise ratio for the operating channel, and/or an amount of interference on the operating channel.

For example, the first access point 102 sending the signal 312 on the reporting channel may set and/or start the interval 370 between reporting periods (e.g., a reporting interval) and/or the reporting periods for the other computing devices (e.g., access points) in the area. For example, each reporting period may be separated in time from the next reporting period by the reporting interval. For example, following each reporting period, the first access point 102 may switch from the reporting channel to the operating channel for that first access point 102 and begin communicating with one or more devices (e.g., client devices, wireless network extenders, and/or other stations) on its specific network. For example, the computing devices may be configured to communicate with the one or more devices on the operating channel of the computing device during a communication period. For example, the communication period may be equal to or less than the reporting interval 370. For example, the reporting interval 370 may be a predetermined or pre-set amount of time. For example, the reporting interval 370 may be 50 ms. For example, the computing devices may communicate with the one or more devices during the communication period and until the end of the reporting interval. Once the end of the reporting interval is reached, it is the next reporting period and the computing device switches from the operating channel to the reporting channel and both sends another signal on the reporting channel and listens for other computing devices sending signals on the reporting channel during the reporting period. For example, the computing device may determine when to listen and when to send signals by using a mechanism called Clear Channel Assessment (CCA), where the computing device actively listens on the reporting channel before sending its signal, to ensure the reporting channel is clear, effectively following a listen before speaking approach to avoid signal collisions with other computing devices on the reporting channel. If the reporting channel is busy, the computing device waits for a short period before attempting to send its signal on the reporting channel again. The computing devices may then switch back and forth between reporting periods (on the reporting channel) and communication periods (on the operating channel of the particular computing device) based on the reporting interval 370.

For example, the first access point 102 sending the signal 312 on the reporting channel may start the reporting interval 370 for both the first access point 102 and the other access points (e.g., access points 104, 106, 108, 110) in the area that are in communication range of the first access point 102. The first access point 102 may switch from the reporting channel to the operating channel for the first access point (e.g., channel 5). During the communication period and the reporting interval 370, the first access point 102 may send one or more beacon signals 314-320 on the operating channel 5 as well as listen for and communicate with devices on the operating channel 5 in the first access point's network.

Once the end of the reporting interval 370 is reached and/or the communication period is completed, the next reporting period is reached and the first access point 102 may switch from its operating channel 5 to the reporting channel. The first access point 102 may, during a portion of the reporting period, send a second signal 322 on the reporting channel. For example, the second signal 322 may be a beacon signal. For example, the second signal 322 may indicate or include the operating channel for the first access point 102. For example, the second signal 322 may indicate or include one or more of an identifier for the first access point 102, a bandwidth utilization for the operating channel, a number of devices communicating on the operating channel, a signal-to-noise ratio for the operating channel, and/or an amount of interference on the operating channel.

The first access point 102 may also listen on the reporting channel for a portion (e.g., second portion) of the reporting period. For example, the first access point 102 may determine when to listen and when to send signals by using a mechanism called Clear Channel Assessment (CCA), where the first access point 102 actively listens on the reporting channel before sending its signal, to ensure the reporting channel is clear, effectively following a listen before speaking approach to avoid signal collisions with other computing devices on the reporting channel. If the reporting channel is busy, the first access point 102 waits for a short period before attempting to send its signal on the reporting channel again. For example, the first access point 102 may listen for other computing devices (e.g., access points) reporting on the reporting channel. For example, the first access point 102 may hear or receive a first signal 342 sent by the second access point 104 during the portion of the reporting period. The first signal 342 may be a beacon signal and may indicate or include the operating channel (e.g., channel 37) for or associated with the second access point 104. The first signal from the second access point 104 may also include or indicate one or more of an identifier for the second access point 104, a bandwidth utilization for the operating channel of the second access point 104, a number of devices communicating on the operating channel of the second access point 104, a signal-to-noise ratio for the operating channel of the second access point 104, and/or an amount of interference on the operating channel of the second access point 104. For example, the reporting period may be a predetermined or pre-set amount of time. For example, the reporting period may be 10 ms or any other amount of time.

At the completion of the reporting period the reporting interval 370 may begin again and the next communication period may begin for the first access point 102. The first access point 102 may switch from the reporting channel to the operating channel for the first access point (e.g., channel 5). During this next communication period and the reporting interval 370, the first access point 102 may send one or more beacon signals (e.g., similar to the beacon signals 314-320) on the operating channel 5 as well as listen for and communicate with devices on the operating channel 5 in the first access point's network.

Once the end of the reporting interval 370 is reached and/or the communication period is completed, the next reporting period is reached and the first access point 102 may switch from its operating channel 5 to the reporting channel. The first access point 102 may, during a portion of the reporting period, send a third signal 362 on the reporting channel. For example, the third signal 362 may be a beacon signal. For example, the third signal 362 may be substantially the same and include the same information as the second signal 322.

The first access point 102 may also listen on the reporting channel for a portion (e.g., second portion) of the next reporting period. For example, the first access point 102 may listen for other computing devices (e.g., access points) reporting on the reporting channel. For example, the first access point 102 may hear or receive a second signal 364 sent by the second access point 104 during the portion of the reporting period. For example, the first access point 102 may hear or receive a first signal 360 sent by the third access point 106 during the portion of the reporting period. The first signal 360 may be a beacon signal and may indicate or include the operating channel (e.g., channel 69) for or associated with the third access point 106. The first signal from the third access point 106 may also include or indicate one or more of an identifier for the third access point 106, a bandwidth utilization for the operating channel of the third access point 106, a number of devices communicating on the operating channel of the third access point 106, a signal-to-noise ratio for the operating channel of the third access point 106, and/or an amount of interference on the operating channel of the third access point 106. For example, the second signal 364 of the second access point 104 may be substantially the same and include the same information as the first signal 342. The first access point 102 may store the information (e.g., the device IDs, the operating channels, the bandwidth utilization, the SNR, the number of devices on a particular channel, and/or amount of interference) received from the second access point 104 and the third access point 106 in a storage device 103 associated with the first access point 102. For example, the first access point 102 may store the information in a file or record associated with the particular device ID of the second access point 104 and third access point respectively. For example, the first access point 102 my subsequently use the information received during the reporting period from other access points to determine which channel to switch to when changing operating channels at the first access point 102.

At the completion of the reporting period the reporting interval 370 may begin again and the next communication period may begin for the first access point 102. The first access point 102 may switch from the reporting channel to the operating channel for the first access point (e.g., channel 5). During this next communication period and the reporting interval 370, the first access point 102 may send one or more beacon signals (e.g., similar to the beacon signals 314-320) on the operating channel 5 as well as listen for and communicate with devices on the operating channel 5 in the first access point's network. The process for the first access point 102 may then continue with transitioning between the communication periods (on the operating channel for the first access point) and the reporting periods (on the reporting channel) for as long as the first access point 102 operates without a loss of power, a reset, or a change of location.

Returning to the beginning of the timelines, the access point 104 may be turned on, reset, or brought into the area from another location. The second access point 104 may typically wirelessly communicate with other devices on a second operating channel of a frequency band. For example, the frequency band may be the 5 gigahertz frequency band or the 6 gigahertz frequency band. For example, the operating channel for the second access point 104 may be any channel of the frequency band other than the reporting channel. For example, the second operating channel may be channel 37 of the 6 gigahertz frequency band.

The second access point 104 may switch or change channels that it is communicating on from the second operating channel to the reporting channel. The second access point 104 may switch channels because the second access point 104 was just turned on, reset, moved into a new area, and/or does not know the reporting interval or reporting period for reporting information on the reporting channel at 324. After switching to the reporting channel, the second access point 104 may switch to a listening mode and begin listening for other communications on the reporting channel. For example, the second access point 104 may listen on the reporting channel for a listening period 326-332. The listening period 326-332 may be any amount of time and/or may be a predetermined or pre-set amount of time that the second access point 104 listens on the reporting channel to hear if other computing devices (e.g., access points) are sending signals that indicate their respective operating channels. For example, the listening period 326-332 may be greater than the operating channel communication period for the second access point 104. For example, the listening period 326-332 may be greater than the reporting interval. For example, the listening period may be the same for each of the computing devices. For example, the second access point 104 may exit a listening period when it receives or hears a signal from another computing device on the reporting channel.

The second access point 104 may listen on the reporting channel for a first portion 326 of the listening period. The second access point 104 may determine that it did not hear or receive any signals from other access points during the first portion 326. The second access point 104 may determine that the entirety of the listening period has not yet expired (e.g., the maximum listening time has not been reached). The second access point 104 may then listen on the reporting channel for a second portion 328 of the listening period. The second access point 104 may determine that it did not hear or receive any signals from other access points during the second portion 328 of the listening period. The second access point 104 may determine that the entirety of the listening period has not yet expired. The second access point 104 may then listen on the reporting channel for a third portion 330 of the listening period. The second access point 104 may determine that it did not hear or receive any signals from other access points during the third portion 330 of the listening period. The second access point 104 may determine that the entirety of the listening period has not yet expired. The second access point 104 may then listen on the reporting channel for a fourth portion 332 of the listening period. The second access point 104 may determine that it heard or received a wireless signal 312 during the fourth portion 332 of the listening period on the reporting channel. The second access point 104 may determine that the signal 312 is associated with the first access point 102. For example, the second access point 104 receiving or hearing the signal 312 on the reporting channel may start the reporting interval 370 for the second access point. For example, the second access point 104 may determine the reporting interval 370 and/or the start of the reporting interval based on receiving the signal 312 from the first access point 102. By determining the start of the reporting interval based on receiving the signal 312 from another access point, each of the first access point 102 and the second access point 104 will be generally aligned in the timing of their respective communication periods and reporting periods such that they will each be able to receive the signals from the other computing devices during the reporting period on the reporting channel. For example, the reporting interval 370 may be the same for both the first access point 102 and the second access point 104.

For example, the second access point 104 receiving the signal 312 on the reporting channel may start the reporting interval 370 for the second access point 104. The second access point 104 may switch from the reporting channel to the operating channel for the second access point 104 (e.g., channel 37). During the communication period and the reporting interval 370, the second access point 104 may send one or more beacon signals 334-340 on the operating channel 37 as well as listen for and communicate with devices on the operating channel 37 in the second access point's network.

Once the end of the reporting interval 370 is reached and/or the communication period is completed, the next reporting period is reached and the second access point 104 may switch from its operating channel 37 to the reporting channel. The second access point 104 may, during a portion of the reporting period, send a first signal 342 on the reporting channel. For example, the first signal 342 may be a beacon signal. For example, the first signal 342 may indicate or include the operating channel for the second access point 104. For example, the first signal 342 may indicate or include one or more of an identifier for the second access point 104, a bandwidth utilization for the operating channel of the second access point 104, a number of devices communicating on the operating channel of the second access point 104, a signal-to-noise ratio for the operating channel of the second access point 104, and/or an amount of interference on the operating channel of the second access point 104. For example, the first access point 102 may hear or receive the first signal 342 from the second access point 104 during the reporting period.

The second access point 104 may also listen on the reporting channel for a portion (e.g., second portion) of the reporting period. For example, the second access point 104 may determine when to listen and when to send signals by using a mechanism called Clear Channel Assessment (CCA), where the second access point actively listens on the reporting channel before sending its signal, to ensure the reporting channel is clear, effectively following a listen before speaking approach to avoid signal collisions with other computing devices on the reporting channel. If the reporting channel is busy, the second access point 104 waits for a short period before attempting to send its signal on the reporting channel again. For example, the second access point 104 may listen for other computing devices (e.g., access points) reporting on the reporting channel. For example, the second access point 104 may hear or receive the second signal 322 sent by the first access point 102 during the portion of the reporting period. For example, the reporting period for the second access point 104 may be the same as the reporting period for the first access point.

At the completion of the reporting period the reporting interval 370 may begin again and the next communication period may begin for the second access point 104. The second access point 104 may switch from the reporting channel to the operating channel for the second access point 104 (e.g., channel 37). During this next communication period and the reporting interval 370, the second access point 104 may send one or more beacon signals (e.g., similar to the beacon signals 334-340) on the operating channel 37 as well as listen for and communicate with devices on the operating channel 37 in the second access point's network.

Once the end of the reporting interval 370 is reached and/or the communication period is completed, the next reporting period is reached and the second access point 104 may switch from its operating channel 37 to the reporting channel. The second access point 104 may, during a portion of the reporting period, send a second signal 364 on the reporting channel. For example, the second signal 364 may be a beacon signal. For example, the second signal 364 may be substantially the same and include the same information as the first signal 342.

The second access point 104 may also listen on the reporting channel for a portion (e.g., second portion) of the next reporting period. For example, the second access point 104 may listen for other computing devices (e.g., access points) reporting on the reporting channel. For example, the second access point 104 may hear or receive the third signal 362 sent by the first access point 102 during the portion of the reporting period. For example, the second access point 104 may hear or receive the first signal 360 sent by the third access point 106 during the portion of the reporting period. For example, the third signal 362 of the first access point 102 may be substantially the same and include the same information as the second signal 322. The second access point 102 may store the information (e.g., the device IDs, the operating channels, the bandwidth utilization, the SNR, the number of devices on a particular channel, and/or amount of interference) received from the first access point 102 and the third access point 106 in a storage device 105 associated with the second access point 104. For example, the second access point 104 may store the information in a file or record associated with the particular device ID of the first access point 102 and third access point 106 respectively. For example, the second access point 104 my subsequently use the information received during the reporting period from other access points to determine which channel to switch to when changing operating channels at the second access point 104.

At the completion of the reporting period the reporting interval 370 may begin again and the next communication period may begin for the second access point 104. The second access point 104 may switch from the reporting channel to the operating channel for the second access point (e.g., channel 37). During this next communication period and the reporting interval 370, the second access point 104 may send one or more beacon signals (e.g., similar to the beacon signals 334-340) on the operating channel 37 as well as listen for and communicate with devices on the operating channel 37 in the second access point's network. The process for the second access point 104 may then continue with transitioning between the communication periods (on the operating channel for the second access point) and the reporting periods (on the reporting channel) for as long as the second access point 104 operates without a loss of power, a reset, or a change of location.

Returning to the beginning of the timelines, the third access point 106 may be turned on, reset, or brought into the area from another location. The third access point 106 may typically wirelessly communicate with other devices on a third operating channel of a frequency band. For example, the frequency band may be the 5 gigahertz frequency band or the 6 gigahertz frequency band. For example, the third operating channel for the third access point 106 may be any channel of the frequency band other than the reporting channel. For example, the third operating channel may be channel 69 of the 6 gigahertz frequency band.

The third access point 106 may switch or change channels that it is communicating on from the third operating channel to the reporting channel. The third access point 106 may switch channels because the third access point 106 was just turned on, reset, moved into a new area, and/or does not know the reporting interval or reporting period for reporting information on the reporting channel at 344. After switching to the reporting channel, the third access point 106 may switch to a listening mode and begin listening for other communications on the reporting channel. For example, the third access point 106 may listen on the reporting channel for a listening period 346-350. The listening period 346-350 may be any amount of time and/or may be a predetermined or pre-set amount of time that the third access point 106 listens on the reporting channel to hear if other computing devices (e.g., access points) are sending signals that indicate their respective operating channels. For example, the listening period 346-350 may be greater than the operating channel communication period for the third access point 106. For example, the listening period 346-350 may be greater than the reporting interval. For example, the third access point 106 may exit a listening period when it receives or hears a signal from another computing device on the reporting channel.

The third access point 106 may listen on the reporting channel for a first portion 346 of the listening period. The third access point 106 may determine that it did not hear or receive any signals from other access points during the first portion 346. The third access point 106 may determine that the entirety of the listening period has not yet expired (e.g., the maximum listening time has not been reached). The third access point 106 may then listen on the reporting channel for a second portion 348 of the listening period. The third access point 106 may determine that it did not hear or receive any signals from other access points during the second portion 348 of the listening period. The third access point 106 may determine that the entirety of the listening period has not yet expired. The third access point 106 may then listen on the reporting channel for a third portion 350 of the listening period. The third access point 106 may determine that it heard or received one or more wireless signals 322, 342 during the third portion 350 of the listening period on the reporting channel. The third access point 106 may determine that the received signal 322 is associated with or from the first access point 102 and the received signal 342 is associated with or from the second access point 104. For example, the third access point 106 receiving or hearing the one of the signals 322, 342 on the reporting channel may start the reporting interval 370 for the third access point 106. For example, the third access point 106 may determine the reporting interval 370 and/or the start of the reporting interval based on receiving the one of the signals 322, 342 from the first access point 102 and/or the second access point 104 respectively. By determining the start of the reporting interval based on receiving one of the signals 322, 342 from another access point, each of the first access point 102, the second access point 104, and the third access point 106 will be generally aligned in the timing of their respective communication periods and reporting periods such that they will each be able to receive the signals from the other computing devices during the reporting period on the reporting channel. For example, the reporting interval 370 may be the same for each of the first access point 102, the second access point 104, and the third access point 106.

For example, the third access point 106 receiving one of the signals 322, 342 (e.g., the first signal received) on the reporting channel may start the reporting interval 370 for the third access point 106. The third access point 106 may switch from the reporting channel to the operating channel for the third access point 106 (e.g., channel 69). During the communication period and the reporting interval 370, the third access point 106 may send one or more beacon signals 352-358 on the operating channel 69 as well as listen for and communicate with devices on the operating channel 69 in the third access point's network.

Once the end of the reporting interval 370 is reached and/or the communication period is completed, the next reporting period is reached and the third access point 106 may switch from its operating channel 69 to the reporting channel. The third access point 106 may, during a portion of the reporting period, send a first signal 360 on the reporting channel. For example, the first signal 360 may be a beacon signal. For example, the first signal 360 may indicate or include the operating channel for the third access point 106. For example, the first signal 360 may indicate or include one or more of an identifier for the third access point 106, a bandwidth utilization for the operating channel of the third access point 106, a number of devices communicating on the operating channel of the third access point 106, a signal-to-noise ratio for the operating channel of the third access point 106, and/or an amount of interference on the operating channel of the third access point 106. For example, the first access point 102 and the second access point 104 may hear or receive the first signal 360 from the third access point 106 during the reporting period.

The third access point 106 may also listen on the reporting channel for a portion (e.g., second portion) of the reporting period. For example, the third access point 106 may determine when to listen and when to send signals by using a mechanism called Clear Channel Assessment (CCA), where the third access point 106 actively listens on the reporting channel before sending its signal, to ensure the reporting channel is clear, effectively following a listen before speaking approach to avoid signal collisions with other computing devices on the reporting channel. If the reporting channel is busy, the third access point 106 waits for a short period before attempting to send its signal on the reporting channel again. For example, the third access point 106 may listen for other computing devices (e.g., access points) reporting on the reporting channel. For example, the third access point 106 may hear or receive the third signal 362 sent by the first access point 102 and the second signal 364 sent by the second access point 104 during the portion of the reporting period. For example, the reporting period for the third access point 106 may be the same as the reporting period for the first access point 102 and the second access point 104.

At the completion of the reporting period the reporting interval 370 may begin again and the next communication period may begin for the third access point 106. The second access point 106 may switch from the reporting channel to the operating channel for the third access point 106 (e.g., channel 69). During this next communication period and the reporting interval 370, the third access point 106 may send one or more beacon signals on the third operating channel 69 (e.g., similar to the beacon signals 352-358) as well as listen for and communicate with devices on the third operating channel 69 in the second access point's network.

Once the end of the reporting interval 370 is reached and/or the communication period is completed, the next reporting period is reached and the third access point 106 may switch from its operating channel 69 to the reporting channel. The third access point 106 may, during a portion of the reporting period, send another signal on the reporting channel. For example, the signal may be a beacon signal. For example, the signal may be substantially the same and include the same information as the first signal 360.

The third access point 106 may also listen on the reporting channel for a portion (e.g., second portion) of the next reporting period. For example, the third access point 106 may listen for other computing devices (e.g., access points) reporting on the reporting channel. The third access point 106 may store the information (e.g., the device IDs, the operating channels, the bandwidth utilization, the SNR, the number of devices on a particular channel, and/or amount of interference) received from the first access point 102 and the second access point 104 in a storage device 107 associated with the third access point 106. For example, the third access point 106 may store the information in a file or record associated with the particular device ID of the first access point 102 and second access point 104 respectively. For example, the third access point 106 my subsequently use the information received during the reporting period from other access points to determine which channel to switch to when changing operating channels at the third access point 106.

At the completion of the reporting period the reporting interval 370 may begin again and the next communication period may begin for the third access point 106. The third access point 106 may switch from the reporting channel to the operating channel for the third access point (e.g., channel 69). During this next communication period and the reporting interval 370, the third access point 106 may send one or more beacon signals (e.g., similar to the beacon signals 352-358) on the third operating channel 69 as well as listen for and communicate with devices on the third operating channel 69 in the third access point's network. The process for the third access point 106 may then continue with transitioning between the communication periods (on the operating channel for the second access point) and the reporting periods (on the reporting channel) for as long as the third access point 106 operates without a loss of power, a reset, or a change of location.

While the example method 300 is described above with three access points, this is for example purposes only. The number of computing devices (e.g., access points) can be more or less than three and still operate in substantially the same manner.

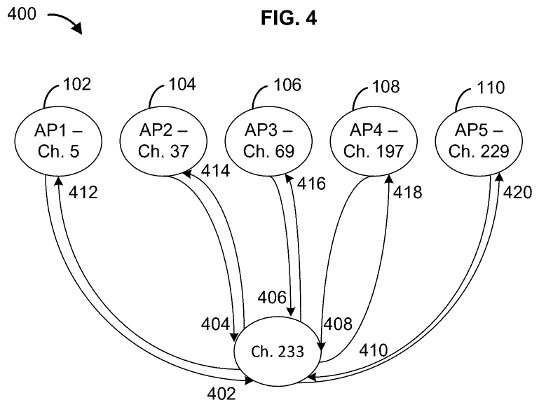

FIG. 4 shows an example system 400 for communicating operating channel information on a reporting channel. The system 400 may include a first computing device 102. For example, the first computing device may be a gateway, router, or access point 102. For example, the first computing device 102 may wirelessly communicate with other devices (not shown), such as client devices and/or stations, on a first operating channel in a first network. For example, the first operating channel may be a channel of a frequency band. For example, the first operating channel may be channel 5 in the 6 gigahertz frequency band.

The system 400 may include a second computing device 104. For example, the second computing device may be a gateway, router, or access point 104. For example, the second computing device 104 may wirelessly communicate with other devices (not shown), such as client devices and/or stations, on a second operating channel in a second network. For example, the second operating channel may be a channel of a frequency band. For example, the second operating channel may be the same or different from the first operating channel. For example, the second operating channel may be channel 37 in the 6 gigahertz frequency band.

The system 400 may include a third computing device 106. For example, the third computing device may be a gateway, router, or access point 106. For example, the third computing device 106 may wirelessly communicate with other devices (not shown), such as client devices and/or stations, on a third operating channel in a third network. For example, the third operating channel may be a channel of a frequency band. For example, the third operating channel may be the same or different from the first operating channel and/or the second operating channel. For example, the third operating channel may be channel 69 in the 6 gigahertz frequency band.

The system 400 may include a fourth computing device 108. For example, the fourth computing device may be a gateway, router, or access point 108. For example, the fourth computing device 108 may wirelessly communicate with other devices (not shown), such as client devices and/or stations, on a fourth operating channel in a fourth network. For example, the fourth operating channel may be a channel of a frequency band. For example, the fourth operating channel may be the same or different from the first operating channel, the second operating channel and/or the third operating channel. For example, the fourth operating channel may be channel 197 in the 6 gigahertz frequency band.

The system 400 may include a fifth computing device 110. For example, the fifth computing device may be a gateway, router, or access point 110. For example, the fifth computing device 110 may wirelessly communicate with other devices (not shown), such as client devices and/or stations, on a fifth operating channel in a fifth network. For example, the fifth operating channel may be a channel of a frequency band. For example, the fifth operating channel may be the same or different from the first operating channel, the second operating channel, the third operating channel, and/or the fourth operating channel. For example, the fifth operating channel may be channel 229 in the 6 gigahertz frequency band.

Each of the computing devices 102-110 may be located in an area or within a range such that each computing device 102-110 may be capable of hearing, detecting, and/or receiving signals from each other computing device 102-110. Each of the computing devices 102-110 may determine a reporting interval and/or the start of a reporting interval based on the methods described in FIG. 3 such that each of the computing devices 102-110 may determine the reporting interval or the start of the reporting interval based on the respective computing device 102-110 sending a signal on the reporting channel or receiving a signal from another computing device 102-110 on the reporting channel. For example, based on the reporting interval and the received or sent signal on the reporting channel, each of the computing devices 102-110 may have substantially temporally aligned reporting periods (on the reporting channel) and communication periods (where each computing device 102-110 communicates with other devices on its respective operating channel in its respective network.

The reporting channel can be any channel of the frequency band the computing devices 102-110 are communicating on or another frequency band. For example, the reporting channel may be a channel on the 5 gigahertz or 6 gigahertz frequency band. For example, the reporting channel may be channel 233 of the 6 gigahertz frequency band.

For example, at the end of a reporting interval and/or the beginning of a reporting period the first computing device 102 may switch from its operating channel 5 to the reporting channel 233 the second computing device 104 may switch from its operating channel 37 to the reporting channel 233 , the third computing device 106 may switch from its operating channel 69 to the reporting channel 233, the fourth computing device 108 may switch from its operating channel 197 to the reporting channel 233, and the fifth computing device 110 may switch from its operating channel 229 to the reporting channel 233.

During the reporting period, the first computing device 102 may send a signal 402 on the reporting channel. The signal 402 may be a beacon signal. The signal 402 may indicate or include the operating channel (e.g., channel 5) for the first computing device 102. The signal 402 may indicate or include one or more of the operating channel (e.g., channel 5) for the first computing device 102, an identifier for the first computing device 102, a bandwidth utilization for the operating channel of the first computing device 102, a number of devices communicating on the operating channel of the first computing device 102, a signal-to-noise ratio for the operating channel of the first computing device 102, and/or an amount of interference on the operating channel of the first computing device 102. During another portion of the reporting period, the first computing device 102 may listen for and receive other signals from other computing devices on the reporting channel. For example, the computing device 102 may determine when to listen and when to send signals by using a mechanism called Clear Channel Assessment (CCA), where the computing device 102 actively listens on the reporting channel before sending its signal, to ensure the reporting channel is clear, effectively following a listen before speaking approach to avoid signal collisions with other computing devices on the reporting channel. If the reporting channel is busy, the computing device 102 waits for a short period before attempting to send its signal on the reporting channel again. For example, the first computing device 102 may hear or receive a second signal 404 from the second computing device 104, a third signal 406 from the third computing device 106, a fourth signal 408 from the fourth computing device 108, and/or a fifth signal 410 from the fifth computing device 110. The first computing device 102 may store or save one or more portions of the information included in the received signals 404-410, such as the identifier for the computing device sending the signal, a bandwidth utilization for the operating channel of the computing device sending the signal, a number of devices communicating on the operating channel of the computing device sending the signal, a signal-to-noise ratio for the operating channel of the computing device sending the signal, and/or an amount of interference on the operating channel of the computing device sending the signal. The first computing device 102 may also evaluate the information in the received signals to determine if one or more of the signals was received from a computing device new in the area or for which information is not currently stored by the first computing device 102. For example, the signal may be the first signal sent by a computing device recently added to the area and not previously known to the first computing device. For example, the first computing device 102 may compare the device identifiers in the received one or more signals to a stored list or set of records containing the device IDs associated with signals previously received by the first computing device 102 on the reporting channel. For example, the first computing device 102 may determine to send a second signal on the reporting channel during the next reporting period based on determining that a signal was received during the current reporting period from a computing device previously identified in prior signals received during prior reporting periods or for which the first computing device 102 has not saved information associated with that computing device based on a prior received signal on the reporting channel.

During the same reporting period, the second computing device 104 may send the second signal 404 on the reporting channel. The second signal 404 may be a beacon signal. The second signal 404 may indicate or include one or more of the operating channel (e.g., channel 37) for the second computing device 104, an identifier for the second computing device 104, a bandwidth utilization for the operating channel of the second computing device 104, a number of devices communicating on the operating channel of the second computing device 104, a signal-to-noise ratio for the operating channel of the second computing device 104, and/or an amount of interference on the operating channel of the second computing device 104. During another portion of the reporting period, the second computing device 104 may listen for and receive other signals from other computing devices on the reporting channel. For example, the second computing device 104 may hear or receive the first signal 402 from the first computing device 102, the third signal 406 from the third computing device 106, the fourth signal 408 from the fourth computing device 108, and/or the fifth signal 410 from the fifth computing device 110. The second computing device 104 may store or save one or more portions of the information included in the received signals 402 and 406-410, such as the identifier for the computing device sending the signal, a bandwidth utilization for the operating channel of the computing device sending the signal, a number of devices communicating on the operating channel of the computing device sending the signal, a signal-to-noise ratio for the operating channel of the computing device sending the signal, and/or an amount of interference on the operating channel of the computing device sending the signal. The second computing device 104 may also evaluate the information in the received signals to determine if one or more of the signals was received from a computing device new in the area or for which information is not currently stored by the second computing device 104. For example, the signal may be the first signal sent by a computing device recently added to the area and not previously known to the second computing device 104. For example, the second computing device 104 may compare the device identifiers in the received one or more signals during this reporting period to a stored list or set of records containing the device IDs associated with signals previously received by the second computing device 104 on the reporting channel in prior reporting periods. For example, the second computing device 104 may determine to send and send a second signal on the reporting channel during the next reporting period based on determining that a signal was received during the current reporting period from a computing device previously identified in prior signals received during prior reporting periods or for which the second computing device 104 has not saved information associated with that computing device based on a prior received signal on the reporting channel.

During the same reporting period, the third computing device 106 may send the third signal 406 on the reporting channel. The third signal 406 may be a beacon signal. The third signal 406 may indicate or include one or more of the operating channel (e.g., channel 69) for the third computing device 106, an identifier for the third computing device 106, a bandwidth utilization for the operating channel of the third computing device 106, a number of devices communicating on the operating channel of the third computing device 106, a signal-to-noise ratio for the operating channel of the third computing device 106, and/or an amount of interference on the operating channel of the third computing device 106. During another portion of the reporting period, the third computing device 106 may listen for and receive other signals from other computing devices on the reporting channel. For example, the third computing device 106 may hear or receive the first signal 402 from the first computing device 102, the second signal 404 from the second computing device 104, the fourth signal 408 from the fourth computing device 108, and/or the fifth signal 410 from the fifth computing device 110. The third computing device 106 may store or save one or more portions of the information included in the received signals 402-404 and 408-410, such as the identifier for the computing device sending the signal, a bandwidth utilization for the operating channel of the computing device sending the signal, a number of devices communicating on the operating channel of the computing device sending the signal, a signal-to-noise ratio for the operating channel of the computing device sending the signal, and/or an amount of interference on the operating channel of the computing device sending the signal. The third computing device 106 may also evaluate the information in the received signals to determine if one or more of the signals was received from a computing device new in the area or for which information is not currently stored by the third computing device 106. For example, the signal may be the first signal sent by a computing device recently added to the area and not previously known to the third computing device 106. For example, the third computing device 106 may compare the device identifiers in the received one or more signals during this reporting period to a stored list or set of records containing the device IDs associated with signals previously received by the third computing device 106 on the reporting channel in prior reporting periods. For example, the third computing device 106 may determine to send and send a second signal on the reporting channel during the next reporting period based on determining that a signal was received during the current reporting period from a computing device previously identified in prior signals received during prior reporting periods or for which the third computing device 106 has not saved information associated with that computing device based on a prior received signal on the reporting channel.

During the same reporting period, the fourth computing device 108 may send the fourth signal 408 on the reporting channel. The fourth signal 408 may be a beacon signal. The fourth signal 408 may indicate or include one or more of the operating channel (e.g., channel 197) for the fourth computing device 108, an identifier for the fourth computing device 108, a bandwidth utilization for the operating channel of the fourth computing device 108, a number of devices communicating on the operating channel of the fourth computing device 108, a signal-to-noise ratio for the operating channel of the fourth computing device 108, and/or an amount of interference on the operating channel of the fourth computing device 108. During another portion of the reporting period, the fourth computing device 108 may listen for and receive other signals from other computing devices on the reporting channel. For example, the fourth computing device 108 may hear or receive the first signal 402 from the first computing device 102, the second signal 404 from the second computing device 104, the third signal 406 from the third computing device 106, and/or the fifth signal 410 from the fifth computing device 110. The fourth computing device 108 may store or save one or more portions of the information included in the received signals 402-406 and 410, such as the identifier for the computing device sending the signal, a bandwidth utilization for the operating channel of the computing device sending the signal, a number of devices communicating on the operating channel of the computing device sending the signal, a signal-to-noise ratio for the operating channel of the computing device sending the signal, and/or an amount of interference on the operating channel of the computing device sending the signal. The fourth computing device 108 may also evaluate the information in the received signals to determine if one or more of the signals was received from a computing device new in the area or for which information is not currently stored by the fourth computing device 108. For example, the signal may be the first signal sent by a computing device recently added to the area and not previously known to the fourth computing device 108. For example, the fourth computing device 108 may compare the device identifiers in the received one or more signals during this reporting period to a stored list or set of records containing the device IDs associated with signals previously received by the fourth computing device 108 on the reporting channel in prior reporting periods. For example, the fourth computing device 108 may determine to send and send a second signal on the reporting channel during the next reporting period based on determining that a signal was received during the current reporting period from a computing device previously identified in prior signals received during prior reporting periods or for which the fourth computing device 108 has not saved information associated with that computing device based on a prior received signal on the reporting channel.

During the same reporting period, the fifth computing device 110 may send the fifth signal 410 on the reporting channel. The fifth signal 410 may be a beacon signal. The fifth signal 410 may indicate or include one or more of the operating channel (e.g., channel 229) for the fifth computing device 110, an identifier for the fifth computing device 110, a bandwidth utilization for the operating channel of the fifth computing device 110, a number of devices communicating on the operating channel of the fifth computing device 110, a signal-to-noise ratio for the operating channel of the fifth computing device 110, and/or an amount of interference on the operating channel of the fifth computing device 110. During another portion of the reporting period, the fifth computing device 110 may listen for and receive other signals from other computing devices on the reporting channel. For example, the fifth computing device 110 may hear or receive the first signal 402 from the first computing device 102, the second signal 404 from the second computing device 104, the third signal 406 from the third computing device 106, and/or the fourth signal 408 from the fourth computing device 108. The fifth computing device 110 may store or save one or more portions of the information included in the received signals 402-408, such as the identifier for the computing device sending the signal, a bandwidth utilization for the operating channel of the computing device sending the signal, a number of devices communicating on the operating channel of the computing device sending the signal, a signal-to-noise ratio for the operating channel of the computing device sending the signal, and/or an amount of interference on the operating channel of the computing device sending the signal. The fifth computing device 110 may also evaluate the information in the received signals to determine if one or more of the signals was received from a computing device new in the area or for which information is not currently stored by the fifth computing device 110. For example, the signal may be the first signal sent by a computing device recently added to the area and not previously known to the fifth computing device 110. For example, the fifth computing device 110 may compare the device identifiers in the received one or more signals during this reporting period to a stored list or set of records containing the device IDs associated with signals previously received by the fifth computing device 110 on the reporting channel in prior reporting periods. For example, the fifth computing device 110 may determine to send and send a second signal on the reporting channel during the next reporting period based on determining that a signal was received during the current reporting period from a computing device previously identified in prior signals received during prior reporting periods or for which the fifth computing device 110 has not saved information associated with that computing device based on a prior received signal on the reporting channel.

For example, at the end of a reporting period and/or the beginning of a communication period the first computing device 102 may switch from the reporting channel 233 to its operating channel 5, the second computing device 104 may switch from the reporting channel 233 to its operating channel 37, the third computing device 106 may switch from the reporting channel 233 to its operating channel 69, the fourth computing device 108 may switch from the reporting channel 233 to its operating channel 197, and the fifth computing device 110 may switch from the reporting channel 233 to its operating channel 229. During the communication period, the first computing device 102 may send one or more signals 412 on and receive communications from other devices on its operating channel 5, the second computing device 104 may send one or more signals 414 on and receive communications from other devices on its operating channel 37, the third computing device 106 may send one or more signals 416 on and receive communications from other devices on its operating channel 69, the fourth computing device 108 may send one or more signals 418 on and receive communications from other devices on its operating channel 197, and the fifth computing device 110 may send one or more signals 420 on and receive communications from other devices on its operating channel 229. Once the reporting interval ends and/or the communication period ends, each of the computing devices 102-110 may switch back to the reporting channel to send and receive signals with information associated with their respective operating channels.

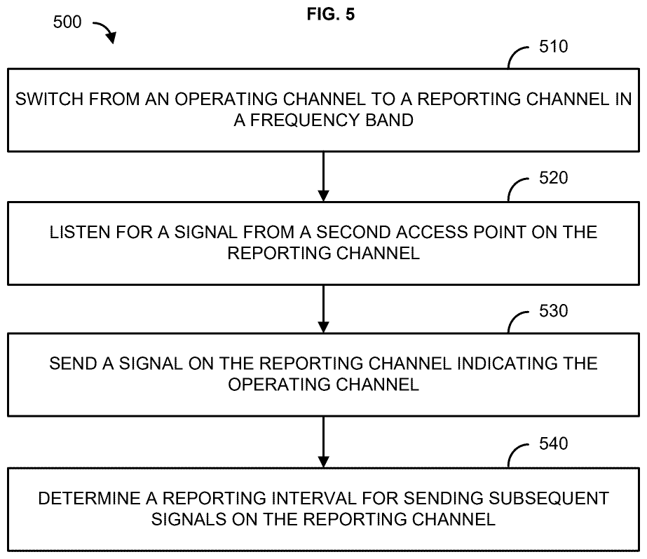

FIG. 5 is a flowchart illustrating an example method 500 for communicating operating channel information on a reporting channel (e.g., a common reporting channel). The method 500 may be completed by a computing device, such as any of the computing devices 102-110 of FIG. 1. For example, the computing device may be an access point, a gateway, or a router. For example, the computing device may be configured to wirelessly communicate via one or more wireless communication protocols, such as WI-FI, Bluetooth, Zigbee or the like. For example, the computing device may be configured to wirelessly communicate with one or more other devices (e.g., client devices, stations, etc.) on a network via an operating channel of a frequency band. For example, the frequency band can be one of a 5 gigahertz frequency band or a 6 gigahertz frequency band. For example, the operating channel for the computing device may be any channel of the frequency band other than the reporting channel. The reporting channel may be any channel on the frequency band. For example, the reporting channel may be the highest frequency channel on the frequency band. For example, the reporting channel may be channel 233 of the 6 gigahertz frequency band.

The computing device may be turned on, reset, or brought into the area from another location. At 510, the computing device may switch or change channels that it is communicating on from the operating channel to the reporting channel in the frequency band. For example, the computing device may switch channels because the computing device was just turned on, reset, moved into a new area, and/or does not know the reporting interval or reporting period for reporting information on the reporting channel.

At 520, the computing device may begin a listening mode and begin listening for other communications from other computing devices (e.g., other access points) on the reporting channel. For example, the computing device may initially listen on the reporting channel for a listening period. The listening period may be any amount of time and/or may be a predetermined or pre-set amount of time that the computing device initially listens on the reporting channel to hear if other computing devices (e.g., access points) are sending signals that indicate their respective operating channels. For example, the listening period may be greater than an operating channel communication period for the computing device, during which the computing device communicates with other devices on the operating channel associated with the computing device. For example, the listening period may be greater than a reporting interval. For example, the listening period may be 50 milliseconds (ms). For example, the listening period may be any amount between and including 1 ms-5000 ms.

The computing device may listen on the reporting channel for a first portion of the listening period and determine that it did not hear or receive any signals from other access points. The computing device may determine that the entirety of the listening period has not yet expired (e.g., the maximum listening time has not been reached). Based on the determination that the maximum listing time has not been reached, the computing device may then listen on the reporting channel for a second portion of the listening period and determine that it did not hear or receive any signals from other access points during the second portion of the listening period. The computing device may determine that the entirety of the listening period has not yet expired. Based on the determination that the maximum listing time has not been reached, the computing device may then listen on the reporting channel for a third portion of the listening period and determine that it did not hear or receive any signals from other access points during the third portion of the listening period. The computing device may determine that the entirety of the listening period has expired or been completed. The computing device may determine, based on not hearing signals from any other access points during the listening period that there are no other access points reporting on the reporting channel.

At 530, the computing device may send or transmit a wireless signal on the reporting channel. For example, the computing device may send the signal based on not receiving or hearing any signals from other computing devices on the reporting channel during the listening period. For example, the signal may be a beacon signal. For example, the signal may indicate or include one or more of the operating channel for or associated with the computing device, an identifier for the computing device (e.g., a MAC address, name, unique address, etc.), a bandwidth utilization for the operating channel of the computing device, a number of devices communicating on the operating channel of the computing device, a signal-to-noise ratio for the operating channel of the computing device, and/or an amount of interference on the operating channel of the computing device.

For example, the computing device sending the signal on the reporting channel after not hearing or receiving other signals during the listening period may set and/or start a reporting interval between reporting periods and/or the reporting periods for computing device and other computing devices within range of sending and/or receiving wireless signals with the computing device.

At 540, the computing device may determine the reporting interval and/or the start of the reporting interval for sending subsequent signals on the reporting channel. For example, the computing device may determine the reporting interval and/or the start of the reporting interval based on sending the initial signal on the reporting channel after not hearing signals from other computing devices during the listening period. For example, sending the initial signal on the reporting channel may trigger or start the reporting interval for the computing device. For example, the computing device may determine the subsequent reporting periods for reporting (e.g., sending a signal and listening for signals from other computing devices) on the reporting channel based on sending the initial signal on the reporting channel after not hearing signals from other computing devices during the listening period.

For example, each reporting period may be separated in time from the next reporting period by the reporting interval. For example, following each reporting period, the computing device may switch from the reporting channel to the operating channel for that computing device and begin communicating with one or more devices (e.g., client devices, wireless network extenders, and/or other stations) on its specific network. For example, the computing device may be configured to communicate with the one or more devices on the operating channel of the computing device during a communication period. For example, the communication period may be equal to or less than the reporting interval. For example, the reporting interval may be a predetermined or pre-set amount of time. For example, the reporting interval may be 50 ms.

For example, the computing devices may communicate with the one or more devices on the operating channel during the communication period and until the end of the reporting interval. Once the end of the reporting interval is reached, it is the next reporting period and the computing device may switch from its operating channel to the reporting channel. For example, the reporting period may be a predetermined or pre-set amount of time. For example, the reporting period may be 10 ms or any other amount of time.

The computing device may, during a portion of the reporting period, send a second signal on the reporting channel. For example, the second signal may be a beacon signal. For example, the second signal may indicate or include one or more of the operating channel for the computing device, an identifier for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device.

The computing device may also listen on the reporting channel for a portion (e.g., second portion) of the reporting period. For example, the computing device may determine when to listen and when to send signals by using a mechanism called Clear Channel Assessment (CCA), where the computing device actively listens on the reporting channel before sending its signal, to ensure the reporting channel is clear, effectively following a listen before speaking approach to avoid signal collisions with other computing devices on the reporting channel. If the reporting channel is busy, the computing device waits for a short period before attempting to send its signal on the reporting channel again. For example, the computing device may listen, then send the second signal, then listen again; may listen, then send the second signal; or may send the second signal and then listen on the reporting channel during the reporting period. For example, the computing device may listen for other computing devices (e.g., access points) reporting on the reporting channel. For example, the computing device may hear or receive a first signal sent by a second computing device during the portion of the reporting period. The first signal of the second computing device may be a beacon signal and may indicate or include one or more of the operating channel for or associated with the second computing device, an identifier (e.g., MAC address, name, unique address, etc.) for the second computing device, a bandwidth utilization for the operating channel of the second computing device, a number of devices communicating on the operating channel of the second computing device, a signal-to-noise ratio for the operating channel of the second computing device, and/or an amount of interference on the operating channel of the second computing device. While the example of FIG. 5 describes only receiving one signal from one other computing device, this is for example purposes only as the number of other computing devices can be any amount and can result in the computing device receiving substantially similar signals as described above on the reporting channel that provide the same types of information as above from tens or hundreds of other computing devices.

The computing device may store the information (e.g., the device IDs, the operating channels, the bandwidth utilization, the SNR, the number of devices on a particular channel, and/or amount of interference) received from the signals of the other computing devices on the reporting channel during the reporting period in a storage device associated with the computing device. For example, the computing device may store the information in a file or record associated with the particular device ID of a respective other computing device from which the signal was received. For example, the computing device my subsequently use the information received during the reporting period from the other computing devices to determine which channel to switch to when changing operating channels at the computing device.

At the completion of the reporting period the reporting interval may begin again and the next communication period may begin for the computing device. The computing device may switch from the reporting channel to the operating channel for the computing device. During this next communication period and the reporting interval, the computing device may send one or more beacon signals on the operating channel, as well as listen for and communicate with devices on the operating channel in the computing device's network. The process for the computing device may then continue with transitioning between the communication periods (on the operating channel for the computing device) and the reporting periods (on the reporting channel) for as long as the computing device operates without a loss of power, a reset, or a change of location.

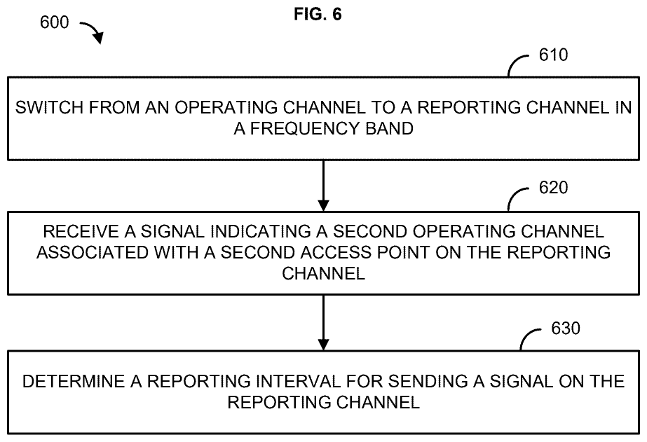

FIG. 6 is a flowchart illustrating an example method 600 for communicating operating channel information on a reporting channel (e.g., a common reporting channel). The method 600 may be completed by a computing device, such as any of the computing devices 102-110 of FIG. 1. For example, the computing device may be an access point, a gateway, or a router. For example, the computing device may be configured to wirelessly communicate via one or more wireless communication protocols, such as WI-FI, Bluetooth, Zigbee or the like. For example, the computing device may be configured to wirelessly communicate with one or more other devices (e.g., client devices, stations, etc.) on a network via an operating channel of a frequency band. For example, the frequency band can be one of a 5 gigahertz frequency band or a 6 gigahertz frequency band. For example, the operating channel for the computing device may be any channel of the frequency band other than the reporting channel. The reporting channel may be any channel on the frequency band. For example, the reporting channel may be the highest frequency channel on the frequency band. For example, the reporting channel may be channel 233 of the 6 gigahertz frequency band.

The computing device may be turned on, reset, or brought into the area from another location. At 610, the computing device may switch or change channels that it is communicating on from the operating channel to the reporting channel in the frequency band. For example, the computing device may switch channels because the computing device was just turned on, reset, moved into a new area, and/or does not know the reporting interval or reporting period for reporting information on the reporting channel.

The computing device may begin a listening mode and begin listening for other communications from other computing devices (e.g., other access points) on the reporting channel. For example, the computing device may initially listen on the reporting channel for a listening period. The listening period may be any amount of time and/or may be a predetermined or pre-set amount of time that the computing device initially listens on the reporting channel to hear if other computing devices (e.g., access points) are sending signals that indicate their respective operating channels. For example, the listening period may be greater than an operating channel communication period for the computing device, during which the computing device communicates with other devices on the operating channel associated with the computing device. For example, the listening period may be greater than a reporting interval. For example, the listening period may be 50 milliseconds (ms). For example, the listening period may be any amount between and including 1 ms-5000 ms. For example, once the computing device hears or receives a signal from another computing device on the reporting channel, the listening period may immediately end or terminate.

The computing device may listen on the reporting channel for a first portion of the listening period and determine that it did not hear or receive any signals from other access points. The computing device may determine that the entirety of the listening period has not yet expired (e.g., the maximum listening time has not been reached). Based on the determination that the maximum listing time has not been reached, the computing device may then listen on the reporting channel for a second portion of the listening period.

At 620, the computing device may hear or receive a signal on the reporting channel. For example, the computing device may hear or receive a signal during the listening period. For example, the signal may have been sent by a second computing device on the reporting channel. For example, the computing device and the second computing device may be within communication range of one another. For example, the second computing device may be an access point, a gateway, or a router.

The computing device may determine that the received signal is associated with the second computing device. For example, the signal may be a beacon signal. For example, the signal may indicate or include one or more of the operating channel for or associated with the second computing device, an identifier for the second computing device (e.g., a MAC address, name, unique address, etc.), a bandwidth utilization for the operating channel of the second computing device, a number of devices communicating on the operating channel of the second computing device, a signal-to-noise ratio for the operating channel of the second computing device, and/or an amount of interference on the operating channel of the second computing device.

The computing device may store the information (e.g., the device IDs, the operating channels, the bandwidth utilization, the SNR, the number of devices on a particular channel, and/or amount of interference) received from the signal of the second computing device on the reporting channel listening period in a storage device associated with the computing device. For example, the computing device may store the information in a file or record associated with the particular device ID of the second computing device from which the signal was received.

At 630, the computing device may determine the reporting interval and/or the start of the reporting interval for sending subsequent signals on the reporting channel. For example, the computing device may determine the reporting interval and/or the start of the reporting interval based on receiving the initial signal (e.g., the first signal that the computing device receives) on the reporting channel from the second computing device during the listening period. For example, receiving the initial signal on the reporting channel from the second computing device during the listening period may trigger or start the reporting interval for the computing device. For example, the computing device may determine the subsequent reporting periods for reporting (e.g., sending a signal and listening for signals from other computing devices) on the reporting channel based on receiving the initial signal on the reporting channel from the second computing device during the listening period.

For example, each reporting period may be separated in time from the next reporting period by the reporting interval. For example, following each reporting period, the computing device may switch from the reporting channel to the operating channel for that computing device and begin communicating with one or more devices (e.g., client devices, wireless network extenders, and/or other stations) on its specific network. For example, the computing device may be configured to communicate with the one or more devices on the operating channel of the computing device during a communication period. For example, the communication period may be equal to or less than the reporting interval. For example, the reporting interval may be a predetermined or pre-set amount of time. For example, the reporting interval may be 50 ms.

By determining the start of the reporting interval based on receiving the signal from the second computing device, each of the computing device and the second computing device will be generally aligned in the timing of their respective communication periods and reporting periods such that they will each be able to receive the signals from the other computing devices during the reporting period on the reporting channel. For example, the reporting interval may be the same for both the computing device and the second computing device (as well as all other computing devices that report and are within a communication range of the second computing device).

For example, after receiving the initial signal during the listening period from the second computing device, the computing device may switch from the reporting channel to the operating channel for the computing device. During the communication period and the reporting interval, the computing device may send one or more beacon signals on the operating channel of the computing device as well as listen for and communicate with devices on the operating channel of the computing device in the computing device's network.

For example, the computing devices may communicate with the one or more devices on the operating channel during the communication period and until the end of the reporting interval. Once the end of the reporting interval is reached, it is the next reporting period and the computing device may switch from its operating channel to the reporting channel. For example, the reporting period may be a predetermined or pre-set amount of time. For example, the reporting period may be 10 ms or any other amount of time.

The computing device may, during a portion of the reporting period, send a signal on the reporting channel. For example, the signal may be a beacon signal. For example, the second signal may indicate or include one or more of the operating channel for the computing device, an identifier for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device.

The computing device may also listen on the reporting channel for a portion (e.g., second portion) of the reporting period. For example, the computing device may determine when to listen and when to send signals by using a mechanism called Clear Channel Assessment (CCA), where the computing device actively listens on the reporting channel before sending its signal, to ensure the reporting channel is clear, effectively following a listen before speaking approach to avoid signal collisions with other computing devices on the reporting channel. If the reporting channel is busy, the computing device waits for a short period before attempting to send its signal on the reporting channel again. For example, the computing device may listen for other computing devices (e.g., access points) reporting on the reporting channel. For example, the computing device may hear or receive a second signal sent by the second computing device during the portion of the reporting period. The second signal of the second computing device may be a beacon signal and may indicate or include one or more of the operating channel for or associated with the second computing device, an identifier (e.g., MAC address, name, unique address, etc.) for the second computing device, a bandwidth utilization for the operating channel of the second computing device, a number of devices communicating on the operating channel of the second computing device, a signal-to-noise ratio for the operating channel of the second computing device, and/or an amount of interference on the operating channel of the second computing device. While the example of FIG. 6 describes only receiving one signal from one other computing device, this is for example purposes only as the number of other computing devices can be any amount and can result in the computing device receiving substantially similar signals as described above on the reporting channel that provide the same types of information as above from tens or hundreds of other computing devices.

The computing device may store the information (e.g., the device IDs, the operating channels, the bandwidth utilization, the SNR, the number of devices on a particular channel, and/or amount of interference) received from the signals of the other computing devices on the reporting channel during the reporting period in a storage device associated with the computing device. For example, the computing device may store the information in a file or record associated with the particular device ID of a respective other computing device from which the signal was received. For example, the computing device my subsequently use the information received during the reporting period from the other computing devices to determine which channel to switch to when changing operating channels at the computing device.

At the completion of the reporting period the reporting interval may begin again and the next communication period may begin for the computing device. The computing device may switch from the reporting channel to the operating channel for the computing device. During this next communication period and the reporting interval, the computing device may send one or more beacon signals on the operating channel, as well as listen for and communicate with devices on the operating channel in the computing device's network. The process for the computing device may then continue with transitioning between the communication periods (on the operating channel for the computing device) and the reporting periods (on the reporting channel) for as long as the computing device operates without a loss of power, a reset, or a change of location.

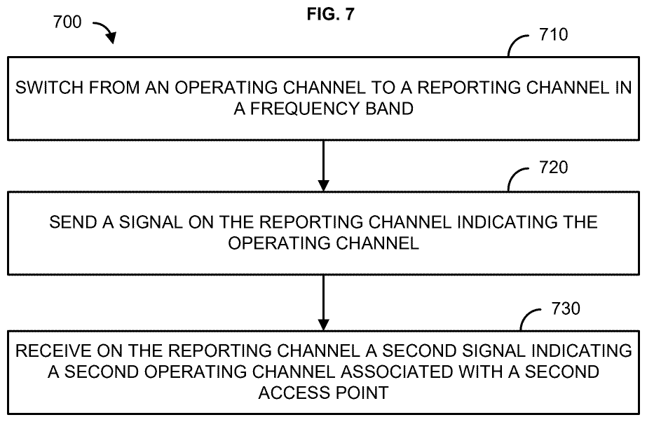

FIG. 7 is a flowchart illustrating an example method 700 for communicating operating channel information on a reporting channel (e.g., a common reporting channel). The method 700 may be completed by a computing device, such as any of the computing devices 102-110 of FIG. 1. For example, the computing device may be an access point, a gateway, or a router. For example, the computing device may be configured to wirelessly communicate via one or more wireless communication protocols, such as WI-FI, Bluetooth, Zigbee or the like. For example, the computing device may be configured to wirelessly communicate with one or more other devices (e.g., client devices, stations, etc.) on a network via an operating channel of a frequency band. For example, the frequency band may be one of a 5 gigahertz frequency band or a 6 gigahertz frequency band. For example, the operating channel for the computing device may be any channel of the frequency band other than the reporting channel. The reporting channel may be any channel on the frequency band. For example, the reporting channel may be the highest or lowest frequency channel on the frequency band. For example, the reporting channel may be channel 233 of the 6 gigahertz frequency band.

The computing device may determine a reporting interval and/or the start of the reporting interval for sending signals on the reporting channel. For example, the computing device may determine the reporting interval and/or the start of the reporting interval based on either of the methodologies described in FIGS. 5-6 above (e.g., sending the initial signal after not receiving other signals during a listening mode or receiving a signal from another computing device during the listening mode). For example, the computing device may determine the reporting periods for reporting (e.g., sending a signal and listening for signals from other computing devices) on the reporting channel based on the reporting interval.

For example, each reporting period may be separated in time from the next reporting period by the reporting interval. For example, following each reporting period, the computing device may switch from the reporting channel to the operating channel for that computing device and begin communicating with one or more devices (e.g., client devices, wireless network extenders, and/or other stations) on its specific network. For example, the computing device may be configured to communicate with the one or more devices on the operating channel of the computing device during a communication period. For example, the communication period may be equal to or less than the reporting interval. For example, the reporting interval may be a predetermined or pre-set amount of time. For example, the reporting interval may be 50 ms.

By determining the start of the reporting interval based on sending the initial signal or receiving the signal from the second computing device on the reporting channel, each of the computing devices within communication range will be generally aligned in the timing of their respective communication periods and reporting periods such that they will each be able to receive the signals from the other computing devices during the reporting period on the reporting channel. For example, the reporting interval may be the same for each of the computing devices that report and are within a communication range of the computing device.

For example, after sending the initial signal (FIG. 5) or receiving the initial signal (FIG. 6) during the listening period, the computing device may switch from the reporting channel to the operating channel for the computing device. During the communication period and the reporting interval, the computing device may send one or more beacon signals on the operating channel of the computing device as well as listen for and communicate with devices on the operating channel of the computing device in the computing device's network.

At 710, the computing device may switch from the operating channel to the reporting channel in the frequency band. For example, the computing device may switch from the operating channel to the reporting channel based on the reporting interval expiring. For example, the computing device may switch from the operating channel to the reporting channel based on the communication period expiring. For example, the computing device may switch from the operating channel to the reporting channel at substantially the same time (e.g., within 5 ms of each other) that other computing devices switch from their respective operating channel to the reporting channel.

For example, the computing device may communicate with the one or more devices on the operating channel during the communication period and until the end of the reporting interval. Once the end of the reporting interval is reached (e.g., and/or the end of the communication period is reached), the reporting period begins and the computing device may switch from its operating channel to the reporting channel. For example, the reporting period may be a predetermined or pre-set amount of time. For example, the reporting period may be 10 ms or any other amount of time.

At 720, the computing device may send a signal on the reporting channel of the frequency band. For example the signal may indicate the operating channel for the computing device. For example, the computing device may, during a portion of the reporting period, send a signal on the reporting channel. For example, the signal may be a beacon signal. For example, the signal may indicate or include one or more of the operating channel for the computing device, an identifier for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device.

At 730, the computing device may receive a signal on the reporting channel. For example, the received signal may be sent by a second computing device (e.g., a second access point). For example, the received signal may indicate an operating channel for or associated with the second computing device. For example, the computing device may listen on the reporting channel for a portion (e.g., second portion) of the reporting period. For example, the computing device may determine when to listen and when to send signals by using a mechanism called Clear Channel Assessment (CCA), where the computing device actively listens on the reporting channel before sending its signal, to ensure the reporting channel is clear, effectively following a listen before speaking approach to avoid signal collisions with other computing devices on the reporting channel. If the reporting channel is busy, the computing device waits for a short period before attempting to send its signal on the reporting channel again. For example, the computing device may listen for other computing devices (e.g., access points) reporting on the reporting channel. For example, the computing device may hear or receive the signal sent by the second computing device during the portion of the reporting period. The signal of the second computing device may be a beacon signal and may indicate or include one or more of the operating channel for or associated with the second computing device, an identifier (e.g., MAC address, name, unique address, etc.) for the second computing device, a bandwidth utilization for the operating channel of the second computing device, a number of devices communicating on the operating channel of the second computing device, a signal-to-noise ratio for the operating channel of the second computing device, and/or an amount of interference on the operating channel of the second computing device. While the example of FIG. 7 describes only receiving one signal from one other computing device, this is for example purposes only as the number of other computing devices can be any amount and can result in the computing device receiving substantially similar signals as described above on the reporting channel that provide the same types of information as above from tens or hundreds of other computing devices.

The computing device may store the information (e.g., the device IDs, the operating channels, the bandwidth utilization, the SNR, the number of devices on a particular channel, and/or amount of interference) received from the signals of the other computing devices on the reporting channel during the reporting period in a storage device associated with the computing device. For example, the computing device may store the information in a file or record associated with the particular device ID of a respective other computing device from which the signal was received. For example, the computing device my subsequently use the information received during the reporting period from the other computing devices to determine which channel to switch to when changing operating channels at the computing device.

At the completion of the reporting period the reporting interval may begin again and the next communication period may begin for the computing device. The computing device may switch from the reporting channel to the operating channel for the computing device. During this next communication period and the reporting interval, the computing device may send one or more beacon signals on the operating channel, as well as listen for and communicate with devices on the operating channel in the computing device's network. The process for the computing device may then continue with transitioning between the communication periods (on the operating channel for the computing device) and the reporting periods (on the reporting channel) for as long as the computing device operates without a loss of power, a reset, or a change of location.

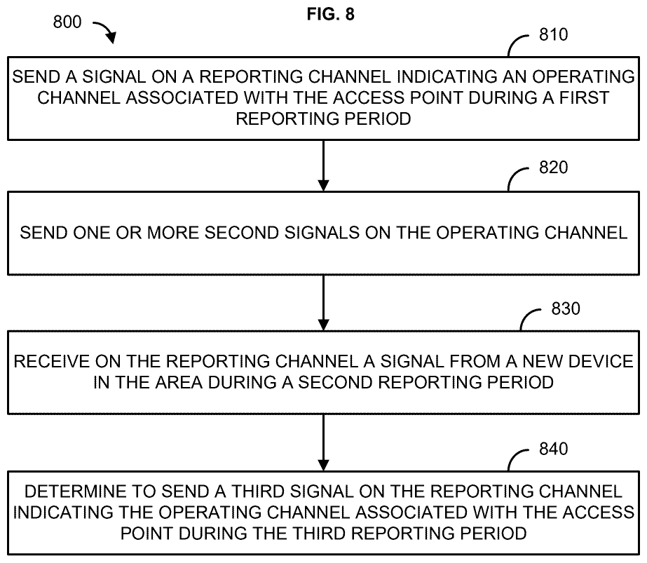

FIG. 8 is a flowchart illustrating an example method 800 for communicating operating channel information on a reporting channel (e.g., a common reporting channel). The method 800 may be completed by a computing device, such as any of the computing devices 102-110 of FIG. 1. For example, the computing device may be an access point, a gateway, or a router. For example, the computing device may be configured to wirelessly communicate via one or more wireless communication protocols, such as WI-FI, Bluetooth, Zigbee or the like. For example, the computing device may be configured to wirelessly communicate with one or more other devices (e.g., client devices, stations, etc.) on a network via an operating channel of a frequency band. For example, the frequency band can be one of a 5 gigahertz frequency band or a 6 gigahertz frequency band. For example, the operating channel for the computing device may be any channel of the frequency band other than the reporting channel. The reporting channel may be any channel on the frequency band. For example, the reporting channel may be the highest frequency channel on the frequency band. For example, the reporting channel may be channel 233 of the 6 gigahertz frequency band.

The computing device may determine a reporting interval and/or the start of the reporting interval for sending signals on the reporting channel. For example, the computing device may determine the reporting interval and/or the start of the reporting interval based on either of the methodologies described in FIGS. 5-6 above (e.g., sending the initial signal after not receiving other signals during a listening mode or receiving a signal from another computing device during the listening mode). For example, the computing device may determine the reporting periods for reporting (e.g., sending a signal and listening for signals from other computing devices) on the reporting channel based on the reporting interval.

For example, each reporting period may be separated in time from the next reporting period by the reporting interval. For example, following each reporting period, the computing device may switch from the reporting channel to the operating channel for that computing device and begin communicating with one or more devices (e.g., client devices, wireless network extenders, and/or other stations) on its specific network. For example, the computing device may be configured to communicate with the one or more devices on the operating channel of the computing device during a communication period. For example, the communication period may be equal to or less than the reporting interval. For example, the reporting interval may be a predetermined or pre-set amount of time. For example, the reporting interval may be 50 ms.

By determining the start of the reporting interval based on sending the initial signal or receiving the signal from the second computing device on the reporting channel, each of the computing devices within communication range will be generally aligned in the timing of their respective communication periods and reporting periods such that they will each be able to receive the signals from the other computing devices during the reporting period on the reporting channel. For example, the reporting interval may be the same for each of the computing devices that report and are within a communication range of the computing device.

For example, after sending the initial signal (FIG. 5) or receiving the initial signal (FIG. 6) during the listening period, the computing device may switch from the reporting channel to the operating channel for the computing device. During the communication period and the reporting interval, the computing device may send one or more beacon signals on the operating channel of the computing device as well as listen for and communicate with devices on the operating channel of the computing device in the computing device's network.

The computing device may switch from the operating channel to the reporting channel in the frequency band. For example, the computing device may switch from the operating channel to the reporting channel based on the reporting interval expiring. For example, the computing device may switch from the operating channel to the reporting channel based on the communication period expiring. For example, the computing device may switch from the operating channel to the reporting channel at substantially the same time (e.g., within 5 ms of each other) that other computing devices switch from their respective operating channel to the reporting channel.

For example, the computing device may communicate with the one or more devices on the operating channel during the communication period and until the end of the reporting interval. Once the end of the reporting interval is reached (e.g., and/or the end of the communication period is reached), the reporting period begins and the computing device may switch from its operating channel to the reporting channel. For example, the reporting period may be a predetermined or pre-set amount of time. For example, the reporting period may be 10 ms or any other amount of time.

At 810, the computing device may send a signal on the reporting channel of the frequency band during a first reporting period. For example the signal may indicate the operating channel for the computing device. For example, the signal may be a beacon signal. For example, the signal may indicate or include one or more of the operating channel for the computing device, an identifier for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device.

The computing device may receive a signal on the reporting channel. For example, the received signal may be sent by a second computing device (e.g., a second access point). For example, the received signal may indicate an operating channel for or associated with the second computing device. For example, the computing device may listen on the reporting channel for a portion (e.g., second portion) of the reporting period. For example, the computing device may determine when to listen and when to send signals by using a mechanism called Clear Channel Assessment (CCA), where the computing device actively listens on the reporting channel before sending its signal, to ensure the reporting channel is clear, effectively following a listen before speaking approach to avoid signal collisions with other computing devices on the reporting channel. If the reporting channel is busy, the computing device waits for a short period before attempting to send its signal on the reporting channel again. For example, the computing device may listen for other computing devices (e.g., access points) reporting on the reporting channel. For example, the computing device may hear or receive the signal sent by the second computing device during the portion of the reporting period. The signal of the second computing device may be a beacon signal and may indicate or include one or more of the operating channel for or associated with the second computing device, an identifier (e.g., MAC address, name, unique address, etc.) for the second computing device, a bandwidth utilization for the operating channel of the second computing device, a number of devices communicating on the operating channel of the second computing device, a signal-to-noise ratio for the operating channel of the second computing device, and/or an amount of interference on the operating channel of the second computing device. While the example of FIG. 8 describes only receiving one signal from one other computing device, this is for example purposes only as the number of other computing devices can be any amount and can result in the computing device receiving substantially similar signals as described above on the reporting channel that provide the same types of information as above from tens or hundreds of other computing devices.

The computing device may store the information (e.g., the device IDs, the operating channels, the bandwidth utilization, the SNR, the number of devices on a particular channel, and/or amount of interference) received from the signals of the other computing devices on the reporting channel during the reporting period in a storage device associated with the computing device. For example, the computing device may store the information in a file or record associated with the particular device ID of a respective other computing device from which the signal was received.

At 820, the computing device may send or transmit one or more signals on the operating channel for the computing device. For example, at the completion of the reporting period the reporting interval may begin again and the next communication period may begin for the computing device. The computing device may switch from the reporting channel to the operating channel for the computing device. During this next communication period and the reporting interval, the computing device may send the one or more signals on the operating channel, as well as listen for and communicate with devices on the operating channel in the computing device's network. For example, the one or more signals may comprise beacon signals. The process for the computing device may then continue with transitioning between the communication periods (on the operating channel for the computing device) and the reporting periods (on the reporting channel).

At times, the computing device may determine to only listen during one or a series of reporting periods on the reporting channel. For example, the area within communication range of the computing device may be somewhat constant with the same other computing devices in the area reporting on the reporting channel. Accordingly each computing device may already know what operating channel and associated network information is for the other computing devices reporting on the reporting channel.

During a subsequent reporting period, the computing device may not send a signal on the reporting channel but may listen for at least a portion of the reporting period for signals from other computing devices on the reporting channel. At 830, during the subsequent reporting period, the computing device may receive a signal from a third computing device on the reporting channel. For example, the computing device may determine that the third computing device is a new computing device in the area. The computing device may determine the third computing device is a new computing device in the area based on not previously having information associated with the third computing device stored, as discussed above.

For example, during or after each reporting period, the computing device may compare the device identifier for each received signal on the reporting channel during that reporting period to the stored device identifiers for other computing devices the computing device received signals from during prior reporting periods. Based on the comparison, the computing device may determine if a signal was received during the current reporting period from a new computing device (e.g., the third computing device with an associated device ID that is not currently stored by the computing device). For example, if the computing device compares the received device ID associated with the third computing device and is not able to identify a match in its stored records of signal information, then the third computing device may be considered a new computing device in the area.

At 840, the computing device may determine to send a signal on the reporting channel during the next reporting period. For example, the computing device may determine to send the signal during the next reporting period based on receiving a signal from the new computing device in the area (e.g., the third computing device) during the current reporting period. For example, the computing device may determine to send the signal during the next reporting period because the new computing device in the area (the third computing device) may have not previously received a signal from the computing device (since the computing device was only listening during the current reporting period when the new computing device was identified. The signal sent by the computing device during the next reporting period may be a beacon signal and may indicate or include one or more of the operating channel for or associated with the computing device, an identifier (e.g., MAC address, name, unique address, etc.) for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device.

For example, if the computing device does not detect a new computing device in the area during the current reporting period (based on receiving a signal from a third computing device for which information was not previously stored by the computing device), the computing device may determine to only listen for signals on the reporting channel during the next reporting period and not send a signal during the next reporting period. The process for the computing device may then continue with transitioning between the communication periods (on the operating channel for the computing device) and the reporting periods (on the reporting channel).

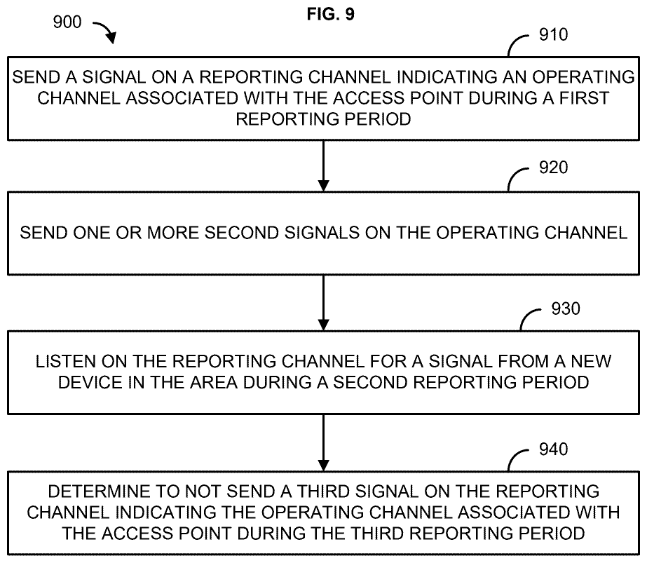

FIG. 9 is a flowchart illustrating an example method 900 for communicating operating channel information on a reporting channel (e.g., a common reporting channel). The method 900 may be completed by a computing device, such as any of the computing devices 102-110 of FIG. 1. For example, the computing device may be an access point, a gateway, or a router. For example, the computing device may be configured to wirelessly communicate via one or more wireless communication protocols, such as WI-FI, Bluetooth, Zigbee or the like. For example, the computing device may be configured to wirelessly communicate with one or more other devices (e.g., client devices, stations, etc.) on a network via an operating channel of a frequency band. For example, the frequency band can be one of a 5 gigahertz frequency band or a 6 gigahertz frequency band. For example, the operating channel for the computing device may be any channel of the frequency band other than the reporting channel. The reporting channel may be any channel on the frequency band. For example, the reporting channel may be the highest frequency channel on the frequency band. For example, the reporting channel may be channel 233 of the 6 gigahertz frequency band.

The computing device may determine a reporting interval and/or the start of the reporting interval for sending signals on the reporting channel. For example, the computing device may determine the reporting interval and/or the start of the reporting interval based on either of the methodologies described in FIGS. 5-6 above (e.g., sending the initial signal after not receiving other signals during a listening mode or receiving a signal from another computing device during the listening mode). For example, the computing device may determine the reporting periods for reporting (e.g., sending a signal and listening for signals from other computing devices) on the reporting channel based on the reporting interval.

For example, each reporting period may be separated in time from the next reporting period by the reporting interval. For example, following each reporting period, the computing device may switch from the reporting channel to the operating channel for that computing device and begin communicating with one or more devices (e.g., client devices, wireless network extenders, and/or other stations) on its specific network. For example, the computing device may be configured to communicate with the one or more devices on the operating channel of the computing device during a communication period. For example, the communication period may be equal to or less than the reporting interval. For example, the reporting interval may be a predetermined or pre-set amount of time. For example, the reporting interval may be 50 ms.

By determining the start of the reporting interval based on sending the initial signal or receiving the signal from the second computing device on the reporting channel, each of the computing devices within communication range will be generally aligned in the timing of their respective communication periods and reporting periods such that they will each be able to receive the signals from the other computing devices during the reporting period on the reporting channel. For example, the reporting interval may be the same for each of the computing devices that report and are within a communication range of the computing device.

For example, after sending the initial signal (FIG. 5) or receiving the initial signal (FIG. 6) during the listening period, the computing device may switch from the reporting channel to the operating channel for the computing device. During the communication period and the reporting interval, the computing device may send one or more beacon signals on the operating channel of the computing device as well as listen for and communicate with devices on the operating channel of the computing device in the computing device's network.

The computing device may switch from the operating channel to the reporting channel in the frequency band. For example, the computing device may switch from the operating channel to the reporting channel based on the reporting interval expiring. For example, the computing device may switch from the operating channel to the reporting channel based on the communication period expiring. For example, the computing device may switch from the operating channel to the reporting channel at substantially the same time (e.g., within 5 ms of each other) that other computing devices switch from their respective operating channel to the reporting channel.

For example, the computing device may communicate with the one or more devices on the operating channel during the communication period and until the end of the reporting interval. Once the end of the reporting interval is reached (e.g., and/or the end of the communication period is reached), the reporting period begins and the computing device may switch from its operating channel to the reporting channel. For example, the reporting period may be a predetermined or pre-set amount of time. For example, the reporting period may be 10 ms or any other amount of time.

At 910, the computing device may send a signal on the reporting channel of the frequency band during a first reporting period. For example the signal may indicate the operating channel for the computing device. For example, the signal may be a beacon signal. For example, the signal may indicate or include one or more of the operating channel for the computing device, an identifier for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device.

The computing device may receive a signal on the reporting channel. For example, the received signal may be sent by a second computing device (e.g., a second access point). For example, the received signal may indicate an operating channel for or associated with the second computing device. For example, the computing device may listen on the reporting channel for a portion (e.g., second portion) of the reporting period. For example, the computing device may determine when to listen and when to send signals by using a mechanism called Clear Channel Assessment (CCA), where the computing device actively listens on the reporting channel before sending its signal, to ensure the reporting channel is clear, effectively following a listen before speaking approach to avoid signal collisions with other computing devices on the reporting channel. If the reporting channel is busy, the computing device waits for a short period before attempting to send its signal on the reporting channel again. For example, the computing device may listen for other computing devices (e.g., access points) reporting on the reporting channel. For example, the computing device may hear or receive the signal sent by the second computing device during the portion of the reporting period. The signal of the second computing device may be a beacon signal and may indicate or include one or more of the operating channel for or associated with the second computing device, an identifier (e.g., MAC address, name, unique address, etc.) for the second computing device, a bandwidth utilization for the operating channel of the second computing device, a number of devices communicating on the operating channel of the second computing device, a signal-to-noise ratio for the operating channel of the second computing device, and/or an amount of interference on the operating channel of the second computing device. While the example of FIG. 9 describes only receiving one signal from one other computing device, this is for example purposes only as the number of other computing devices can be any amount and can result in the computing device receiving substantially similar signals as described above on the reporting channel that provide the same types of information as above from tens or hundreds of other computing devices.

The computing device may store the information (e.g., the device IDs, the operating channels, the bandwidth utilization, the SNR, the number of devices on a particular channel, and/or amount of interference) received from the signals of the other computing devices on the reporting channel during the reporting period in a storage device associated with the computing device. For example, the computing device may store the information in a file or record associated with the particular device ID of a respective other computing device from which the signal was received.

At 920, the computing device may send or transmit one or more signals on the operating channel for the computing device. For example, at the completion of the reporting period the reporting interval may begin again and the next communication period may begin for the computing device. The computing device may switch from the reporting channel to the operating channel for the computing device. During this next communication period and the reporting interval, the computing device may send the one or more signals on the operating channel, as well as listen for and communicate with devices on the operating channel in the computing device's network. For example, the one or more signals may comprise beacon signals. The process for the computing device may then continue with transitioning between the communication periods (on the operating channel for the computing device) and the reporting periods (on the reporting channel).

At times, the computing device may determine to only listen during one or a series of reporting periods on the reporting channel. For example, the area within communication range of the computing device may be somewhat constant with the same other computing devices in the area reporting on the reporting channel. Accordingly each computing device may already know what operating channel and associated network information is for the other computing devices reporting on the reporting channel.

During a subsequent reporting period, the computing device may not send a signal on the reporting channel but may listen for at least a portion of the reporting period for signals from other computing devices on the reporting channel. At 930, during the subsequent reporting period, the computing device may listen for a signal from other computing devices on the reporting channel to determine if a signal is received from a new computing device in the area.

For example, during or after each reporting period, the computing device may compare the device identifier for each received signal on the reporting channel during that reporting period to the stored device identifiers for other computing devices the computing device received signals from during prior reporting periods. Based on the comparison, the computing device may determine if a signal was received during the current reporting period from a new computing device (e.g., the third computing device with an associated device ID that is not currently stored by the computing device). For example, if the computing device compares the received device ID associated with the third computing device and is not able to identify a match in its stored records of signal information, then the third computing device may be considered a new computing device in the area.

For example, based on the comparison of device identifiers received during the current reporting period to stored device identifiers associated with signals received during prior reporting periods from other computing devices on the reporting channel and having all the device identifiers match stored device identifiers, the computing device may determine that a signal was not received from a new computing device in the area during the current reporting period. At 940, the computing device may determine to not send a signal on the reporting channel during the next reporting period. For example, the computing device may determine to not send the signal during the next reporting period based on not receiving a signal during the current reporting period from a new computing device in the area. For example, the computing device may only listen for signals on the reporting channel during the next reporting period. The computing device may then, once again determine if a signal is received during the next reporting period that is from a computing device that is new in the area.

During the next reporting period, the computing device may determine, based on a comparison of device identifiers received in signals during the next reporting period to stored device identifiers received from prior signals, that a signal was received from a new computing device in the area. The computing device may determine to send a signal on the reporting channel during the reporting period that follows this next reporting period. For example, the computing device may determine to send the signal during the reporting period that follows this next reporting period based on receiving the signal from the new computing device in the area (e.g., the third computing device) during the next reporting period. For example, the computing device may determine to send the signal during the reporting period following this next reporting period because the new computing device in the area (the third computing device) may have not previously received a signal from the computing device (since the computing device was only listening during the next reporting period when the new computing device was identified. The signal sent by the computing device during the reporting period following this next reporting period may be a beacon signal and may indicate or include one or more of the operating channel for or associated with the computing device, an identifier (e.g., MAC address, name, unique address, etc.) for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device. The process for the computing device may then continue with transitioning between the communication periods (on the operating channel for the computing device) and the reporting periods (on the reporting channel).

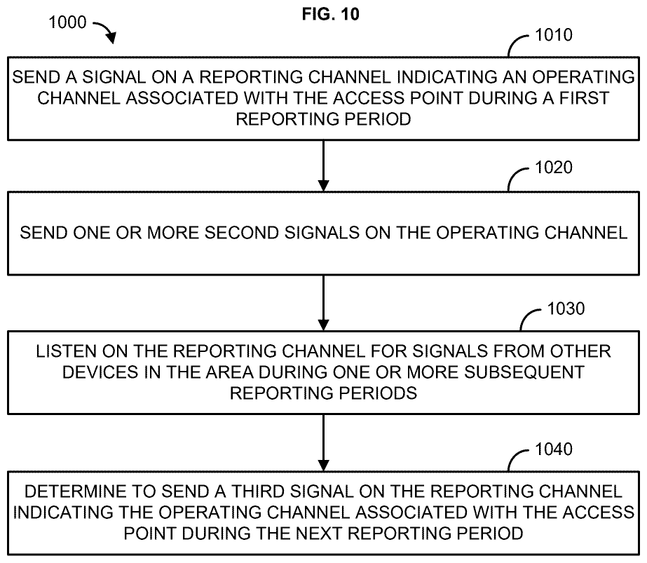

FIG. 10 is a flowchart illustrating an example method 1000 for listening for and communicating operating channel information on a reporting channel (e.g., a common reporting channel). The method 1000 may be completed by a computing device, such as any of the computing devices 102-110 of FIG. 1. For example, the computing device may be an access point, a gateway, or a router. For example, the computing device may be configured to wirelessly communicate with one or more other devices (e.g., client devices, stations, etc.) on a network via an operating channel of a frequency band. For example, the frequency band can be a 6 gigahertz frequency band. For example, the operating channel for the computing device may be any channel of the frequency band other than the reporting channel. The reporting channel may be any channel on the frequency band. For example, the reporting channel may be the highest frequency channel on the frequency band. For example, the reporting channel may be channel 233 of the 6 gigahertz frequency band.

The computing device may determine a reporting interval and/or the start of the reporting interval for sending signals on the reporting channel. For example, the computing device may determine the reporting interval and/or the start of the reporting interval based on either of the methodologies described in FIGS. 5-6 above. For example, the computing device may determine the reporting periods for reporting (e.g., sending a signal and listening for signals from other computing devices) on the reporting channel based on the reporting interval. For example, following each reporting period, the computing device may switch from the reporting channel to the operating channel for that computing device and begin communicating with one or more devices (e.g., client devices, wireless network extenders, and/or other stations) on its specific network. For example, the computing device may be configured to communicate with the one or more devices on the operating channel of the computing device during a communication period. For example, the communication period may be equal to or less than the reporting interval. For example, the reporting interval may be a predetermined or pre-set amount of time. For example, the reporting interval may be 50 ms.

By determining the start of the reporting interval based on sending the initial signal or receiving the signal from the second computing device on the reporting channel, each of the computing devices within communication range will be generally aligned in the timing of their respective communication periods and reporting periods such that they will each be able to receive the signals from the other computing devices during the reporting period on the reporting channel. For example, the reporting interval may be the same for each of the computing devices that report and are within a communication range of the computing device. However, in certain environments there may be so many computing devices in an area trying to report their operating channel and device information during the reporting period that the reporting period may end before all of the computing devices are able to report. As such, one or more of the devices that were able to send a signal on the reporting channel and report their operating channel during one reporting period may only listen during the next reporting period and not send a signal for that next reporting period. For example, the computing device may only listen for multiple subsequent reporting periods and not send a signal after sending a signal during a first reporting period. For example, the computing device may determine to begin sending a beacon signal again on the reporting channel during the reporting period after only listening, and not sending a beacon signal, on the reporting channel for one or more reporting periods. For example, the computing device may determine to begin sending a beacon signal again on the reporting channel based on not hearing any new computing devices sending a beacon signal on the reporting channel during the prior reporting period.

For example, at 1010, the computing device may send a signal on the reporting channel of the frequency band during a first reporting period. For example the signal may indicate the operating channel for the computing device. For example, the signal may be a beacon signal. For example, the signal may indicate or include one or more of the operating channel for the computing device, an identifier for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device.

The computing device may receive one or a plurality of signals on the reporting channel. For example, the received signals may be sent by a plurality of other computing devices (e.g., a second access point). For example, the received signals may indicate an operating channels for or associated with each of the plurality of other computing devices. For example, the computing device may listen on the reporting channel for a portion (e.g., second portion) of the reporting period. For example, the computing device may determine when to listen and when to send signals by using a mechanism called Clear Channel Assessment (CCA), where the computing device actively listens on the reporting channel before sending its signal, to ensure the reporting channel is clear, effectively following a listen before speaking approach to avoid signal collisions with other computing devices on the reporting channel. If the reporting channel is busy, the computing device waits for a short period before attempting to send its signal on the reporting channel again. For example, the computing device may listen for other computing devices (e.g., access points) reporting on the reporting channel. For example, the computing device may hear or receive the signals sent by at least some of the plurality of computing devices during the portion of the reporting period. Each signal of the may be a beacon signal and may indicate or include one or more of the operating channel for or associated with the respective one of the plurality of other computing devices, an identifier (e.g., MAC address, name, unique address, etc.) for the respective one of the plurality of other computing devices, a bandwidth utilization for the operating channel of the respective one of the plurality of computing devices, a number of devices communicating on the operating channel of the respective one of the plurality of computing devices, a signal-to-noise ratio for the operating channel of the respective one of the plurality of other computing devices, and/or an amount of interference on the operating channel of the respective one of the plurality of other computing devices.

The computing device may store the information (e.g., the device IDs, the operating channels, the bandwidth utilization, the SNR, the number of devices on a particular channel, and/or amount of interference) received from the signals of the plurality of other computing devices on the reporting channel during the reporting period in a storage device associated with the computing device. For example, the computing device may store the information in a file or record associated with the particular device ID of a respective other computing device from which the signal was received.

The computing device may determine that it will only listen for signals from other computing devices and not send a beacon signal during the next (e.g. second) reporting period. For example, the computing device may determine that it will only listen based on the computing device sending a beacon signal during the current (e.g., first) reporting period. For example, the computing device may determine that it will only listen based on a portion of the reporting period being taken up with other computing devices sending beacon signals during the reporting period. For example, the portion of the reporting period being taken up may be greater than 70% of the reporting period, greater than 80% of the reporting period, greater than 90% of the reporting period, or 100% of the reporting period. For example, the portion of the reporting period being taken up may indicate that there may be additional computing devices in the area that did not have an opportunity to send a beacon signal during the current (e.g., first) reporting period (e.g., due to the reporting period expiring).

At 1020, the computing device may send or transmit one or more signals on the operating channel for the computing device. For example, at the completion of the reporting period the reporting interval may begin again and the next communication period may begin for the computing device. The computing device may switch from the reporting channel to the operating channel for the computing device. During this next communication period and the reporting interval, the computing device may send the one or more signals on the operating channel, as well as listen for and communicate with devices on the operating channel in the computing device's network. For example, the one or more signals may comprise beacon signals. The process for the computing device may then continue with transitioning between the communication periods (on the operating channel for the computing device) and the reporting periods (on the reporting channel).

At 1030, during one or more subsequent reporting periods (e.g., the second reporting period; the second and third reporting periods; the second, third and fourth reporting periods; etc.), the computing device may not send a signal on the reporting channel but may listen for at least a portion of the reporting period for signals from other computing devices on the reporting channel. The determination by the computing device of how many reporting periods in a row to only listen on the reporting channel and not send a signal may be based on the portion of the reporting period being taken up with other computing devices sending beacon signals during the respective reporting period of the one or more subsequent reporting periods. For example, the portion of the reporting period being taken up may be greater than 70% of the reporting period, greater than 80% of the reporting period, greater than 90% of the reporting period, or 100% of the reporting period. The determination by the computing device how many reporting periods in a row to only listen on the reporting channel and not send a signal may be based on receiving signals during the one or more subsequent reporting periods from one or more computing devices that were not received curing the first reporting period. During the subsequent reporting period, the computing device may receive a signal from one or more other computing devices on the reporting channel. For example, the computing device may determine that the one or more other computing device did not send a beacon signal on the reporting channel during the first reporting period. For example, the computing device may determine one or more of the one or more other computing devices is a new computing device in the area based on not previously having information associated with the respective other computing device stored, as discussed above.

At 1040, the computing device may determine to send a signal on the reporting channel during the next reporting period after the one or more subsequent reporting periods. For example, the computing device may determine to send the signal during the next reporting period based on less than the portion of the reporting period being taken up by other computing devices sending signals during the most recently completed reporting period. For example, the computing device may determine to send the signal during the next reporting period based on the computing device having not sent a beacon signal during the previous X number of reporting periods. For example, the value X can be one, two, three, four, or any other number. For example, when the number of previous reporting periods the computing device has only listened on the reporting channel satisfies the threshold X (e.g., is equal to or greater than), then the computing device may determine that it will send a beacon signal during the next reporting period after the one or more subsequent reporting periods. For example, the computing device may determine to send the signal during the next reporting period because the new computing device in the area (the one or more other computing devices) may have not previously received a signal from the computing device (since the computing device was only listening during the one or more subsequent reporting periods when the new computing device was identified. The signal sent by the computing device during the next reporting period may be a beacon signal and may indicate or include one or more of the operating channel for or associated with the computing device, an identifier (e.g., MAC address, name, unique address, etc.) for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device.

The process for the computing device may then continue with transitioning between the communication periods (on the operating channel for the computing device) and the reporting periods (on the reporting channel).

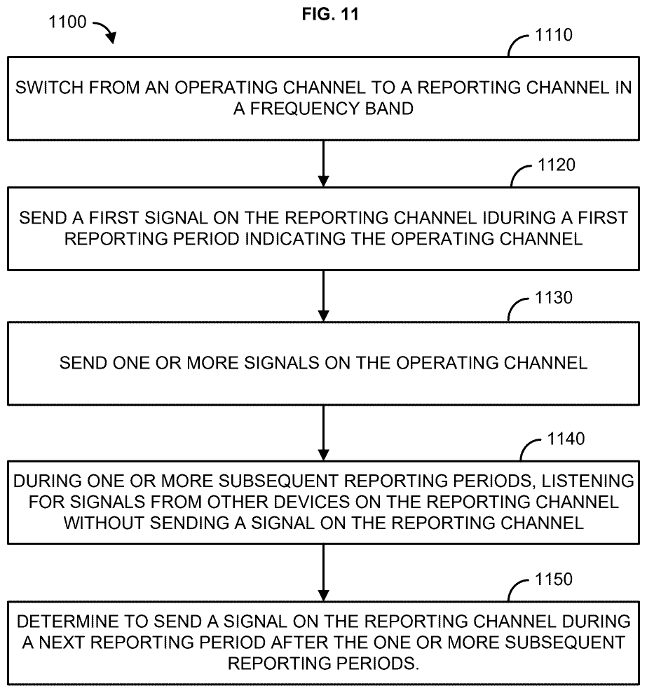

FIG. 11 is a flowchart illustrating an example method 1100 for communicating operating channel information on a reporting channel (e.g., a common reporting channel). The method 1100 may be completed by a computing device, such as any of the computing devices 102-110 of FIG. 1. For example, the computing device may be an access point, a gateway, or a router. For example, the computing device may be configured to wirelessly communicate via one or more wireless communication protocols, such as WI-FI, Bluetooth, Zigbee or the like. For example, the computing device may be configured to wirelessly communicate with one or more other devices (e.g., client devices, stations, etc.) on a network via an operating channel of a frequency band. For example, the frequency band can be one of a 5 gigahertz frequency band or a 6 gigahertz frequency band. For example, the operating channel for the computing device may be any channel of the frequency band other than the reporting channel. The reporting channel may be any channel on the frequency band. For example, the reporting channel may be the highest frequency channel or the lowest frequency channel on the frequency band. For example, the reporting channel may be channel 233 of the 6 gigahertz frequency band.

The computing device may determine a reporting interval and/or the start of the reporting interval for sending signals on the reporting channel. For example, the computing device may determine the reporting interval and/or the start of the reporting interval based on either of the methodologies described in FIGS. 5-6 above (e.g., sending the initial signal after not receiving other signals during a listening mode or receiving a signal from another computing device during the listening mode). For example, the computing device may determine the reporting periods for reporting (e.g., sending a signal and listening for signals from other computing devices) on the reporting channel based on the reporting interval.

For example, each reporting period may be separated in time from the next reporting period by the reporting interval. For example, following each reporting period, the computing device may switch from the reporting channel to the operating channel for that computing device and begin communicating with one or more devices (e.g., client devices, wireless network extenders, and/or other stations) on its specific network. For example, the computing device may be configured to communicate with the one or more devices on the operating channel of the computing device during a communication period. For example, the communication period may be equal to or less than the reporting interval. For example, the reporting interval may be a predetermined or pre-set amount of time. For example, the reporting interval may be 50 ms. For example, the reporting interval may be the same for each of the computing devices that report and are within a communication range of the computing device. For example, the reporting period may be a predetermined or pre-set amount of time. For example, the reporting period may be 10 ms or any other amount of time.

At 1110, the computing device may switch from the operating channel to the reporting channel in the frequency band. For example, the computing device may switch from the operating channel to the reporting channel based on the reporting interval expiring. For example, the computing device may switch from the operating channel to the reporting channel based on the communication period expiring. For example, the computing device may switch from the operating channel to the reporting channel at substantially the same time (e.g., within 5 ms of each other) that other computing devices, in the geographical area and/or that the computing device is within communication range of, switch from their respective operating channel to the same reporting channel.

At 1120, the computing device may send a first signal on the reporting channel of the frequency band during a first reporting period. For example the first signal may indicate the operating channel for the computing device. For example, the first signal may be a beacon signal. For example, the first signal may indicate or include one or more of the operating channel for the computing device, an identifier for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device.

The computing device may receive a plurality of signals on the reporting channel during the first reporting period. For example, the received plurality of signals may each be sent by a corresponding plurality of other computing devices (e.g., a plurality of other access points). For example, each of the received plurality of signals may indicate a corresponding operating channel for or associated with each of the plurality of other computing devices. For example, the computing device may listen on the reporting channel for a portion (e.g., second portion) of the reporting period. For example, the computing device may determine when to listen and when to send signals by using a mechanism called Clear Channel Assessment (CCA), where the computing device actively listens on the reporting channel before sending its signal, to ensure the reporting channel is clear, effectively following a listen before speaking approach to avoid signal collisions with other computing devices on the reporting channel. If the reporting channel is busy, the computing device waits for a short period before attempting to send its signal on the reporting channel again. For example, the computing device may listen for other computing devices (e.g., access points) reporting on the reporting channel. For example, the computing device may hear or receive the plurality of signals sent by the plurality of other computing devices during the portion of the reporting period. Each of the plurality of signals of the plurality of other computing devices may be a beacon signal and may indicate or include one or more of the operating channel for or associated with the respective computing device, an identifier (e.g., MAC address, name, unique address, etc.) for the respective computing device, a bandwidth utilization for the operating channel of the respective computing device, a number of devices communicating on the operating channel of the respective computing device, a signal-to-noise ratio for the operating channel of the respective computing device, and/or an amount of interference on the operating channel of the respective computing device.

The computing device may store the information (e.g., the device IDs, the operating channels, the bandwidth utilization, the SNR, the number of devices on a particular channel, and/or amount of interference) received from the plurality of signals of the plurality of other computing devices on the reporting channel during the reporting period in a storage device associated with the computing device. For example, the computing device may store the information in a file or record associated with the particular device ID of a respective other computing device from which the signal was received.

The computing device may determine to only listen for signals from other computing devices and not send a signal (e.g., a second signal) on the reporting channel during the next reporting period (e.g., the second reporting period). For example, the computing device may determine to only listen for signals from other computing devices and not send a second signal on the reporting channel during the second reporting period based on a portion of the first reporting period being taken up with other computing devices sending signals on the reporting channel during the first reporting period. For example, the portion of the first reporting period may be a majority of the first reporting period. For example, the portion of the first reporting period may be any amount between and including 51%-100% of the time in the first reporting period. For example, the portion of the first reporting period may be an amount of time greater than or greater than or equal to any one of 60%, 70%, 75%, 80%, 90%, 95%, or 100% of the time in the first reporting period.

The computing device may determine how many reporting periods in a row to only listen on the reporting channel and not send a signal during those particular reporting periods. For example, the computing device may determine how many reporting periods in a row to only listen based on receiving one or a plurality of signals during the one or more subsequent reporting periods from one or more other computing devices for which a signal was not received from those one or more other computing devices during the first reporting period. For example, the computing device may determine how many reporting periods in a row to only listen based a predetermined threshold. For example, if the number of listen only periods satisfies the threshold listen only value (e.g., is greater than or greater than or equal to the threshold listen only value) then the computing device will send a signal during the next reporting period. For example, the threshold listen only value may be any number greater than or equal to one. For example, if the threshold listen only value is four, the computing device may, at a maximum, listen only and not send a signal on the reporting channel for four consecutive reporting periods (e.g., reporting periods two through five after sending a signal during the first reporting period above). On the sixth reporting period, the computing device will send a signal on the reporting channel.

At 1130, the computing device may send or transmit one or more signals on the operating channel for the computing device. For example, at the completion of the first reporting period the reporting interval may begin again and the next communication period may begin for the computing device. The computing device may switch from the reporting channel to the operating channel for the computing device. During this next communication period and the reporting interval, the computing device may send the one or more signals on the operating channel, as well as listen for and communicate with devices on the operating channel in the computing device's network. For example, the one or more signals may comprise beacon signals. The process for the computing device may then continue with transitioning between the communication periods (on the operating channel for the computing device) and the reporting periods (on the reporting channel).

At 1140, the computing device may listen for signals from other computing devices and not send a signal on the reporting channel for one or more subsequent reporting periods. During the one or more subsequent reporting periods, the computing device may not send a signal on the reporting channel but may only listen for at least a portion of the reporting period for signals from other computing devices on the reporting channel. For example, during the one or more subsequent reporting periods, the computing device may listen for a signal from other computing devices on the reporting channel to determine if a signal is received from a new computing device in the area or from a computing device from which a signal was not received during the first reporting period.

For example, during or after each reporting period, the computing device may compare the device identifier for each received signal on the reporting channel during that reporting period to the stored device identifiers for other computing devices the computing device received signals from during prior reporting periods. Based on the comparison, the computing device may determine if a signal was received during the current reporting period from a new computing device (e.g., the third computing device with an associated device ID that is not currently stored by the computing device). For example, if the computing device compares the received device ID associated with the third computing device and is not able to identify a match in its stored records of signal information, then the third computing device may be considered a new computing device in the area.

For example, based on the comparison of device identifiers received during the current reporting period to stored device identifiers associated with signals received during prior reporting periods from other computing devices on the reporting channel and having all the device identifiers match stored device identifiers, the computing device may determine that a signal was not received from a new computing device in the area during the current reporting period. For example, the computing device may determine to not send a signal on the reporting channel during the next reporting period. For example, the computing device may determine to not send the signal during the next reporting period based on not receiving a signal during the current reporting period from a new computing device in the area. For example, the computing device may only listen for signals on the reporting channel during the next reporting period. The computing device may then, once again determine if a signal is received during the next reporting period that is from a computing device that is new in the area.

At 1150, the computing device may determine to send a signal on the reporting channel during the next reporting period after the one or more subsequent reporting periods. For example, the computing device may determine to send a signal during the next reporting period, after then one or more subsequent reporting periods, based on the computing device having not sent a signal during the previous X number of reporting periods. For example, X may satisfy the threshold listen only value. For example, the threshold listen only value may be a predetermined or preset value.

During the next reporting period, the computing device may send a signal on the reporting channel. The signal sent by the computing device during the next reporting period may be a beacon signal and may indicate or include one or more of the operating channel for or associated with the computing device, an identifier (e.g., MAC address, name, unique address, etc.) for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device. The process for the computing device may then continue with transitioning between the communication periods (on the operating channel for the computing device) and the reporting periods (on the reporting channel).

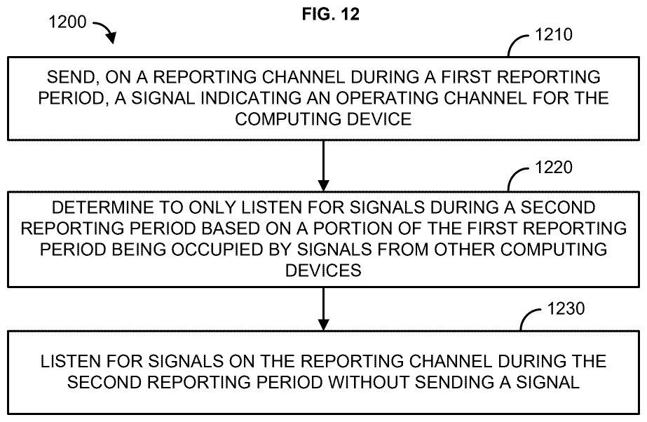

FIG. 12 is a flowchart illustrating an example method 1200 for communicating operating channel information on a reporting channel (e.g., a common reporting channel). The method 1200 may be completed by a computing device, such as any of the computing devices 102-110 of FIG. 1. For example, the computing device may be an access point, a gateway, or a router. For example, the computing device may be configured to wirelessly communicate via one or more wireless communication protocols, such as WI-FI, Bluetooth, Zigbee or the like. For example, the computing device may be configured to wirelessly communicate with one or more other devices (e.g., client devices, stations, etc.) on a network via an operating channel of a frequency band. For example, the frequency band can be one of a 5 gigahertz frequency band or a 6 gigahertz frequency band. For example, the operating channel for the computing device may be any channel of the frequency band other than the reporting channel. The reporting channel may be any channel on the frequency band. For example, the reporting channel may be the highest frequency channel or the lowest frequency channel on the frequency band. For example, the reporting channel may be channel 233 of the 6 gigahertz frequency band.

The computing device may determine a reporting interval and/or the start of the reporting interval for sending signals on the reporting channel. For example, the computing device may determine the reporting interval and/or the start of the reporting interval based on either of the methodologies described in FIGS. 5-6 above (e.g., sending the initial signal after not receiving other signals during a listening mode or receiving a signal from another computing device during the listening mode). For example, the computing device may determine the reporting periods for reporting (e.g., sending a signal and listening for signals from other computing devices) on the reporting channel based on the reporting interval.

For example, each reporting period may be separated in time from the next reporting period by the reporting interval. For example, following each reporting period, the computing device may switch from the reporting channel to the operating channel for that computing device and begin communicating with one or more devices (e.g., client devices, wireless network extenders, and/or other stations) on its specific network. For example, the computing device may be configured to communicate with the one or more devices on the operating channel of the computing device during a communication period. For example, the communication period may be equal to or less than the reporting interval. For example, the reporting interval may be a predetermined or pre-set amount of time. For example, the reporting interval may be 50 ms. For example, the reporting interval may be the same for each of the computing devices that report and are within a communication range of the computing device. For example, the reporting period may be a predetermined or pre-set amount of time. For example, the reporting period may be 10 ms or any other amount of time.

The computing device may switch from the operating channel to the reporting channel in the frequency band. For example, the computing device may switch from the operating channel to the reporting channel based on the reporting interval expiring. For example, the computing device may switch from the operating channel to the reporting channel based on the communication period expiring. For example, the computing device may switch from the operating channel to the reporting channel at substantially the same time (e.g., within 5 ms of each other) that other computing devices, in the geographical area and/or that the computing device is within communication range of, switch from their respective operating channel to the same reporting channel.

At 1210, the computing device may send a first signal on the reporting channel of the frequency band during a first reporting period. For example the first signal may indicate the operating channel for the computing device. For example, the first signal may be a beacon signal. For example, the first signal may indicate or include one or more of the operating channel for the computing device, an identifier for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device.

The computing device may receive one or more signals on the reporting channel during the first reporting period. For example, the received one or more signals may each be sent by a corresponding one or more other computing devices (e.g., a plurality of other access points). For example, each of the one or more signals may indicate a corresponding operating channel for or associated with each of the corresponding one or more other computing devices. For example, the computing device may listen on the reporting channel for a portion (e.g., second portion) of the first reporting period. For example, the computing device may determine when to listen and when to send signals by using a mechanism called Clear Channel Assessment (CCA), where the computing device actively listens on the reporting channel before sending its signal, to ensure the reporting channel is clear, effectively following a listen before speaking approach to avoid signal collisions with other computing devices on the reporting channel. If the reporting channel is busy, the computing device waits for a short period before attempting to send its signal on the reporting channel again. For example, the computing device may listen for other computing devices (e.g., access points) reporting on the reporting channel. For example, the computing device may hear or receive the one or more signals sent by the one or more other computing devices during the portion of the reporting period. Each of the one or more signals of the plurality of other computing devices may be a beacon signal and may indicate or include one or more of the operating channel for or associated with the respective computing device, an identifier (e.g., MAC address, name, unique address, etc.) for the respective computing device, a bandwidth utilization for the operating channel of the respective computing device, a number of devices communicating on the operating channel of the respective computing device, a signal-to-noise ratio for the operating channel of the respective computing device, and/or an amount of interference on the operating channel of the respective computing device.

The computing device may store the information (e.g., the device IDs, the operating channels, the bandwidth utilization, the SNR, the number of devices on a particular channel, and/or amount of interference) received from the one or more signals of the one or more other computing devices on the reporting channel during the reporting period in a storage device associated with the computing device. For example, the computing device may store the information in a file or record associated with the particular device ID of a respective other computing device from which the signal was received.

At 1220, the computing device may determine to only listen for signals from other computing devices and not send a signal (e.g., a second signal) on the reporting channel during the next reporting period (e.g., the second reporting period). For example, the computing device may determine to only listen for signals from other computing devices and not send a second signal on the reporting channel during the second reporting period based on a portion of the first reporting period being taken up with other computing devices sending signals on the reporting channel during the first reporting period. For example, the portion of the first reporting period may be a majority of the first reporting period. For example, the portion of the first reporting period may be any amount between and including 51%-100% of the time in the first reporting period. For example, the portion of the first reporting period may be an amount of time greater than or greater than or equal to any one of 60%, 70%, 75%, 80%, 90%, 95%, or 100% of the time in the first reporting period.

The computing device may determine how many subsequent reporting periods in a row to only listen on the reporting channel and not send a signal during those particular reporting periods. For example, the computing device may determine how many subsequent reporting periods in a row to only listen and not send a signal based on a portion of each of those subsequent reporting period that is occupied with signals from other computing devices. For example, if the portion of a reporting period occupied with signals from other computing devices satisfies a threshold, then the computing device will only listen on the reporting channel and not send a signal during the next subsequent reporting period. For example, the threshold may be any amount between and including 51%-100% of the time in the reporting period. For example, the threshold may be an amount of time greater than or greater than or equal to any one of 60%, 70%, 75%, 80%, 90%, 95%, or 100% of the time in the reporting period.

For example, the computing device may determine how many subsequent reporting periods in a row to only listen and not send a signal based on receiving one or a plurality of signals during the one or more subsequent reporting periods from one or more other computing devices for which a signal was not received from those one or more other computing devices during the first reporting period. For example, the computing device may determine how many reporting periods in a row to only listen and not send a signal on the reporting channel based a predetermined threshold. For example, if the number of listen only periods satisfies the threshold listen only value (e.g., is greater than or greater than or equal to the threshold listen only value) then the computing device will send a signal during the next reporting period following the number of subsequent reporting periods. For example, the threshold listen only value may be any number greater than or equal to one. For example, if the threshold listen only value is four, the computing device may, at a maximum, listen only and not send a signal on the reporting channel for four consecutive reporting periods (e.g., reporting periods two through five after sending a signal during the first reporting period above). On the sixth reporting period, the computing device will send a signal on the reporting channel.

The computing device may switch from the reporting channel back to the operating channel and may send or transmit one or more signals on the operating channel for the computing device. For example, at the completion of the first reporting period the reporting interval may begin again and the next communication period may begin for the computing device. During this next communication period and the reporting interval, the computing device may send the one or more signals on the operating channel, as well as listen for and communicate with devices on the operating channel in the computing device's network. For example, the one or more signals may comprise beacon signals. The process for the computing device may then continue with transitioning between the communication periods (on the operating channel for the computing device) and the reporting periods (on the reporting channel).

At 1230, the computing device may listen for signals from other computing devices without sending a signal on the reporting channel during a second reporting period and potentially additional subsequent reporting periods. During the second reporting period, the computing device may not send a signal on the reporting channel but may only listen during the second reporting period for signals from other computing devices on the reporting channel. For example, during the second reporting period, the computing device may listen for a signal from other computing devices on the reporting channel to determine if a signal is received from a new computing device in the area or from a computing device from which a signal was not received during the first reporting period.

For example, during or after each reporting period, the computing device may compare the device identifier for each received signal on the reporting channel during that reporting period to the stored device identifiers for other computing devices the computing device received signals from during prior reporting periods. Based on the comparison, the computing device may determine if a signal was received during the current reporting period from a new computing device (e.g., the third computing device with an associated device ID that is not currently stored by the computing device). For example, if the computing device compares the received device ID associated with the third computing device and is not able to identify a match in its stored records of signal information, then the third computing device may be considered a new computing device in the area.

For example, the computing device may receive a signal from a new computing device during the second reporting period. For example, based on the comparison of device identifiers received during the second reporting period to stored device identifiers associated with signals received during prior reporting periods the computing device may determine that the received signal if from a new computing device. For example, based on receiving a signal from a new computing device, the computing device may determine to send a signal on the reporting channel during the next (e.g., third) reporting period.

For example, if a signal is not received from a new computing device during the second reporting period, the computing device may determine to only listen and to not send a signal on the reporting channel during the third reporting period.

For example, the computing device may determine to send a signal on the reporting channel during the third or other subsequent reporting period. For example, the computing device may determine to send a signal during the third or other subsequent reporting period, based on or further based on the computing device having not sent a signal during the previous X number of reporting periods. For example, X may satisfy the threshold listen only value. For example, the threshold listen only value may be a predetermined or preset value.

During the next reporting period, the computing device may send a signal on the reporting channel. The signal sent by the computing device during the next reporting period may be a beacon signal and may indicate or include one or more of the operating channel for or associated with the computing device, an identifier (e.g., MAC address, name, unique address, etc.) for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device. The process for the computing device may then continue with transitioning between the communication periods (on the operating channel for the computing device) and the reporting periods (on the reporting channel).

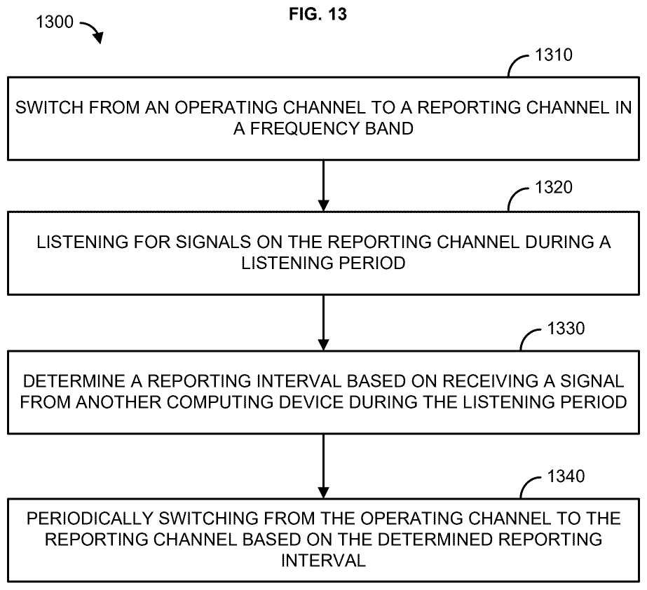

FIG. 13 is a flowchart illustrating an example method 1300 for communicating operating channel information on a reporting channel (e.g., a common reporting channel). The method 1300 may be completed by a computing device, such as any of the computing devices 102-110 of FIG. 1. For example, the computing device may be an access point, a gateway, or a router. For example, the computing device may be configured to wirelessly communicate via one or more wireless communication protocols, such as WI-FI, Bluetooth, Zigbee or the like. For example, the computing device may be configured to wirelessly communicate with one or more other devices (e.g., client devices, stations, etc.) on a network via an operating channel of a frequency band. For example, the frequency band can be one of a 5 gigahertz frequency band or a 6 gigahertz frequency band. For example, the operating channel for the computing device may be any channel of the frequency band other than the reporting channel. The reporting channel may be any channel on the frequency band. For example, the reporting channel may be the highest frequency channel or the lowest frequency channel on the frequency band. For example, the reporting channel may be channel 233 of the 6 gigahertz frequency band.

At 1310, the computing device may switch or change channels that it is communicating on from the operating channel to the reporting channel in the frequency band. For example, the computing device may switch channels because the computing device was just turned on, reset, moved into a new area, and/or does not know the reporting interval or reporting period for reporting information on the reporting channel.

At 1320, the computing device may listen for signals from other computing devices on the reporting channel during a listening period. For example, computing device may begin a listening mode and begin listening for other communications from other computing devices (e.g., other access points) on the reporting channel. For example, the computing device may initially listen on the reporting channel for a listening period. The listening period may be any amount of time and/or may be a predetermined or pre-set amount of time that the computing device initially listens on the reporting channel to hear if other computing devices (e.g., access points) are sending signals that indicate their respective operating channels. For example, the listening period may be greater than an operating channel communication period for the computing device, during which the computing device communicates with other devices on the operating channel associated with the computing device. For example, the listening period may be greater than a reporting interval. For example, the listening period may be 50 milliseconds (ms). For example, the listening period may be any amount between and including 1 ms-5000 ms. For example, once the computing device hears or receives a signal from another computing device on the reporting channel, the listening period may immediately end or terminate.

The computing device may hear or receive a signal from another computing device on the reporting channel. For example, the computing device may hear or receive a signal from another computing device during the listening period. For example, the signal may have been sent by the other computing device on the reporting channel. For example, the computing device and the ptjer computing device may be within communication range of one another. For example, the other computing device may be an access point, a gateway, or a router.

The computing device may determine that the received signal is associated with the other computing device. For example, the received signal may be a beacon signal. For example, the received signal may indicate or include one or more of the operating channel for or associated with the other computing device, an identifier for the other computing device (e.g., a MAC address, name, unique address, etc.), a bandwidth utilization for the operating channel of the other computing device, a number of devices communicating on the operating channel of the other computing device, a signal-to-noise ratio for the operating channel of the other computing device, and/or an amount of interference on the operating channel of the other computing device.

The computing device may store the information (e.g., the device IDs, the operating channels, the bandwidth utilization, the SNR, the number of devices on a particular channel, and/or amount of interference) received from the signal of the other computing device on the reporting channel listening period in a storage device associated with the computing device. For example, the computing device may store the information in a file or record associated with the particular device ID of the second computing device from which the signal was received.

At 1330, the computing device may determine the reporting interval and/or the start of the reporting interval for sending subsequent signals on the reporting channel. For example, the computing device may determine the reporting interval and/or the start of the reporting interval based on receiving the signal from the other computing device on the reporting channel during the listening period. For example, receiving the signal on the reporting channel from the other computing device during the listening period may trigger or start the reporting interval for the computing device. For example, the computing device may determine the subsequent reporting periods for reporting (e.g., sending a signal and/or listening for signals from other computing devices) on the reporting channel based on receiving the signal on the reporting channel from the other computing device during the listening period.

At 1340, the computing device may periodically switch from the operating channel to the reporting channel based on the determined reporting interval. For example, each reporting period may be separated in time from the next reporting period by the reporting interval. For example, following each reporting period, the computing device may switch from the reporting channel to the operating channel for that computing device and begin communicating with one or more devices (e.g., client devices, wireless network extenders, and/or other stations) on its specific network. For example, the computing device may be configured to communicate with the one or more devices on the operating channel of the computing device during a communication period. For example, the communication period may be equal to or less than the reporting interval. For example, the reporting interval may be a predetermined or pre-set amount of time. For example, the reporting interval may be 50 ms.

By determining the start of the reporting interval based on receiving the signal from the other computing device, each of the computing device and the other computing device will be generally aligned in the timing of their respective communication periods and reporting periods such that they will each be able to receive the signals from the other computing devices during the reporting period on the reporting channel. For example, the reporting interval may be the same for both the computing device and the second computing device (as well as all other computing devices that report and are within a communication range of the second computing device).

For example, after receiving the signal during the listening period from the other computing device, the computing device may switch from the reporting channel to the operating channel for the computing device. During the communication period and the reporting interval, the computing device may send one or more beacon signals on the operating channel of the computing device as well as listen for and communicate with devices on the operating channel of the computing device in the computing device's network.

For example, the computing devices may communicate with the one or more devices on the operating channel during the communication period and until the end of the reporting interval. Once the end of the reporting interval is reached, it is the next reporting period and the computing device may switch from its operating channel to the reporting channel. For example, the reporting period may be a predetermined or pre-set amount of time. For example, the reporting period may be 10 ms or any other amount of time.

The computing device may, during a portion of the reporting period, send a signal on the reporting channel. For example, the signal may be a beacon signal. For example, the signal may indicate or include the operating channel for the computing device and/or one or more of an identifier for the computing device, a bandwidth utilization for the operating channel of the computing device, a number of devices communicating on the operating channel of the computing device, a signal-to-noise ratio for the operating channel of the computing device, or an amount of interference on the operating channel of the computing device.

The computing device may also listen on the reporting channel for a portion (e.g., second portion) of the reporting period. For example, the computing device may determine when to listen and when to send signals by using a mechanism called Clear Channel Assessment (CCA), where the computing device actively listens on the reporting channel before sending its signal, to ensure the reporting channel is clear, effectively following a listen before speaking approach to avoid signal collisions with other computing devices on the reporting channel. If the reporting channel is busy, the computing device waits for a short period before attempting to send its signal on the reporting channel again. For example, the computing device may listen for other computing devices (e.g., access points) reporting on the reporting channel. For example, the computing device may hear or receive a second signal sent by the other computing device during the portion of the reporting period. The second signal of the other computing device may be a beacon signal and may indicate or include one or more of the operating channel for or associated with the other computing device, an identifier (e.g., MAC address, name, unique address, etc.) for the other computing device, a bandwidth utilization for the operating channel of the other computing device, a number of devices communicating on the operating channel of the other computing device, a signal-to-noise ratio for the operating channel of the other computing device, and/or an amount of interference on the operating channel of the other computing device. While the example of FIG. 13 describes only receiving one signal from one other computing device, this is for example purposes only as the number of other computing devices can be any amount and can result in the computing device receiving substantially similar signals as described above on the reporting channel that provide the same types of information as above from tens or hundreds of other computing devices.

The computing device may store the information (e.g., the device IDs, the operating channels, the bandwidth utilization, the SNR, the number of devices on a particular channel, and/or amount of interference) received from the signals of the other computing devices on the reporting channel during the reporting period in a storage device associated with the computing device. For example, the computing device may store the information in a file or record associated with the particular device ID of a respective other computing device from which the signal was received. For example, the computing device my subsequently use the information received during the reporting period from the other computing devices to determine which channel to switch to when changing operating channels at the computing device.

At the completion of the reporting period the reporting interval may begin again and the next communication period may begin for the computing device. The computing device may switch from the reporting channel to the operating channel for the computing device. During this next communication period and the reporting interval, the computing device may send one or more beacon signals on the operating channel, as well as listen for and communicate with devices on the operating channel in the computing device's network. The process for the computing device may then continue with transitioning between the communication periods (on the operating channel for the computing device) and the reporting periods (on the reporting channel) for as long as the computing device operates without a loss of power, a reset, or a change of location.

The computing device may determine to only listen for signals from other computing devices and not send a signal (e.g., a second signal) on the reporting channel during the next reporting period. For example, the computing device may determine to only listen for signals from other computing devices and not send a second signal on the reporting channel during the next reporting period based on a portion of the immediately previous reporting period being taken up with other computing devices sending signals on the reporting channel during the immediately previous reporting period. For example, the portion of the immediately previous reporting period may be a majority of the immediately previous reporting period. For example, the portion of the immediately previous reporting period may be any amount between and including 51%-100% of the time in the immediately previous reporting period. For example, the portion of the immediately previous reporting period may be an amount of time greater than or greater than or equal to any one of 60%, 70%, 75%, 80%, 90%, 95%, or 100% of the time in the immediately previous reporting period.

The computing device may determine how many subsequent reporting periods in a row to only listen on the reporting channel and not send a signal during those particular reporting periods. For example, the computing device may determine how many subsequent reporting periods in a row to only listen and not send a signal based on a portion of each of those subsequent reporting period that is occupied with signals from other computing devices. For example, if the portion of a reporting period occupied with signals from other computing devices satisfies a threshold, then the computing device will only listen on the reporting channel and not send a signal during the next subsequent reporting period. For example, the threshold may be any amount between and including 51%-100% of the time in the reporting period. For example, the threshold may be an amount of time greater than or greater than or equal to any one of 60%, 70%, 75%, 80%, 90%, 95%, or 100% of the time in the reporting period.

For example, the computing device may determine how many subsequent reporting periods in a row to only listen and not send a signal based on receiving one or a plurality of signals during the one or more subsequent reporting periods from one or more other computing devices for which a signal was not received from those one or more other computing devices during a prior reporting period. For example, the computing device may determine how many reporting periods in a row to only listen and not send a signal on the reporting channel based a predetermined threshold. For example, if the number of listen only periods satisfies the threshold listen only value (e.g., is greater than or greater than or equal to the threshold listen only value) then the computing device will send a signal during the next reporting period following the number of subsequent reporting periods. For example, the threshold listen only value may be any number greater than or equal to one. For example, if the threshold listen only value is four, the computing device may, at a maximum, listen only and not send a signal on the reporting channel for four consecutive reporting periods. On the next reporting period after the four reporting periods, the computing device will send a signal on the reporting channel.

The computing device may switch from the reporting channel back to the operating channel and may send or transmit one or more signals on the operating channel for the computing device. For example, at the completion of the reporting period the reporting interval may begin again and the next communication period may begin for the computing device. During this next communication period and the reporting interval, the computing device may send the one or more signals on the operating channel, as well as listen for and communicate with devices on the operating channel in the computing device's network. For example, the one or more signals may comprise beacon signals.

After determining to listen only during the next reporting period and during that next reporting period, the computing device may listen for signals from other computing devices without sending a signal on the reporting channel. During that next reporting period, the computing device may not send a signal on the reporting channel but may only listen for signals from other computing devices on the reporting channel. For example, during that next reporting period, the computing device may listen for a signal from other computing devices on the reporting channel to determine if a signal is received from a new computing device in the area or from a computing device from which a signal was not received during the prior reporting period(s).

For example, during or after each reporting period, the computing device may compare the device identifier for each received signal on the reporting channel during that reporting period to the stored device identifiers for other computing devices the computing device received signals from during prior reporting periods. Based on the comparison, the computing device may determine if a signal was received during that next reporting period from a new computing device (e.g., the third computing device with an associated device ID that is not currently stored by the computing device). For example, if the computing device compares the received device ID associated with the third computing device and is not able to identify a match in its stored records of signal information, then the third computing device may be considered a new computing device.

For example, the computing device may receive a signal from a new computing device during that next reporting period. For example, based on the comparison of device identifiers received during that next reporting period to stored device identifiers associated with signals received during prior reporting periods the computing device may determine that the received signal if from a new computing device. For example, based on receiving a signal from a new computing device, the computing device may determine to send a signal on the reporting channel during the subsequent reporting period after that next reporting period.

For example, if a signal is not received from a new computing device during that next reporting period, the computing device may determine to only listen and to not send a signal on the reporting channel during the subsequent reporting period.

For example, the computing device may determine to send a signal on the reporting channel during the subsequent reporting period. For example, the computing device may determine to send a signal during the subsequent reporting period, based on or further based on the computing device having not sent a signal during the previous X number of reporting periods. For example, X may satisfy the threshold listen only value. For example, the threshold listen only value may be a predetermined or preset value.

During the subsequent reporting period, the computing device may send a signal on the reporting channel. The signal sent by the computing device during the subsequent reporting period may be a beacon signal and may indicate or include one or more of the operating channel for or associated with the computing device, an identifier (e.g., MAC address, name, unique address, etc.) for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device. The process for the computing device may then continue with transitioning between the communication periods (on the operating channel for the computing device) and the reporting periods (on the reporting channel).

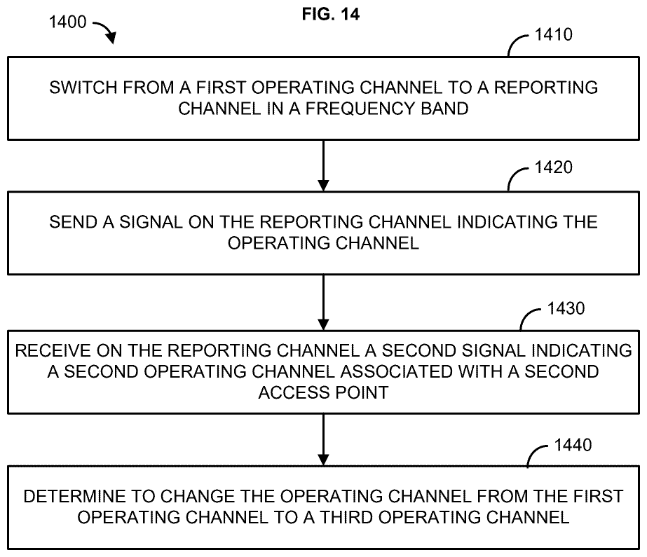

FIG. 14 is a flowchart illustrating an example method 1400 for communicating operating channel information on a reporting channel (e.g., a common reporting channel). The method 1400 may be completed by a computing device, such as any of the computing devices 102-110 of FIG. 1. For example, the computing device may be an access point, a gateway, or a router. For example, the computing device may be configured to wirelessly communicate via one or more wireless communication protocols, such as WI-FI, Bluetooth, Zigbee or the like. For example, the computing device may be configured to wirelessly communicate with one or more other devices (e.g., client devices, stations, etc.) on a network via an operating channel of a frequency band. For example, the frequency band may be one of a 5 gigahertz frequency band or a 6 gigahertz frequency band. For example, the operating channel for the computing device may be any channel of the frequency band other than the reporting channel. The reporting channel may be any channel on the frequency band. For example, the reporting channel may be the highest or lowest frequency channel on the frequency band. For example, the reporting channel may be channel 233 of the 6 gigahertz frequency band.

The computing device may determine a reporting interval and/or the start of the reporting interval for sending signals on the reporting channel. For example, the computing device may determine the reporting interval and/or the start of the reporting interval based on either of the methodologies described in FIGS. 5-6 above (e.g., sending the initial signal after not receiving other signals during a listening mode or receiving a signal from another computing device during the listening mode). For example, the computing device may determine the reporting periods for reporting (e.g., sending a signal and listening for signals from other computing devices) on the reporting channel based on the reporting interval.

For example, each reporting period may be separated in time from the next reporting period by the reporting interval. For example, following each reporting period, the computing device may switch from the reporting channel to the operating channel for that computing device and begin communicating with one or more devices (e.g., client devices, wireless network extenders, and/or other stations) on its specific network. For example, the computing device may be configured to communicate with the one or more devices on the operating channel of the computing device during a communication period. For example, the communication period may be equal to or less than the reporting interval. For example, the reporting interval may be a predetermined or pre-set amount of time. For example, the reporting interval may be 50 ms.

By determining the start of the reporting interval based on sending the initial signal or receiving the signal from the second computing device on the reporting channel, each of the computing devices within communication range will be generally aligned in the timing of their respective communication periods and reporting periods such that they will each be able to receive the signals from the other computing devices during the reporting period on the reporting channel. For example, the reporting interval may be the same for each of the computing devices that report and are within a communication range of the computing device.

For example, after sending the initial signal (FIG. 5) or receiving the initial signal (FIG. 6) during the listening period, the computing device may switch from the reporting channel to the operating channel for the computing device. During the communication period and the reporting interval, the computing device may send one or more beacon signals on the operating channel of the computing device as well as listen for and communicate with devices on the operating channel of the computing device in the computing device's network.

At 1410, the computing device may switch from the operating channel to the reporting channel in the frequency band. For example, the computing device may switch from the operating channel to the reporting channel based on the reporting interval expiring. For example, the computing device may switch from the operating channel to the reporting channel based on the communication period expiring. For example, the computing device may switch from the operating channel to the reporting channel at substantially the same time (e.g., within 5 ms of each other) that other computing devices switch from their respective operating channel to the reporting channel.

For example, the computing device may communicate with the one or more devices on the operating channel during the communication period and until the end of the reporting interval. Once the end of the reporting interval is reached (e.g., and/or the end of the communication period is reached), the reporting period begins and the computing device may switch from its operating channel to the reporting channel. For example, the reporting period may be a predetermined or pre-set amount of time. For example, the reporting period may be 10 ms or any other amount of time.

At 1420, the computing device may send a signal on the reporting channel of the frequency band. For example the signal may indicate the operating channel for the computing device. For example, the computing device may, during a portion of the reporting period, send a signal on the reporting channel. For example, the signal may be a beacon signal. For example, the signal may indicate or include one or more of the operating channel for the computing device, an identifier for the computing device, a bandwidth utilization for the operating channel of the computing device, a number of devices communicating on the operating channel of the computing device, a signal-to-noise ratio for the operating channel of the computing device, and/or an amount of interference on the operating channel of the computing device.

At 1430, the computing device may receive a signal on the reporting channel. For example, the received signal may be sent by a second computing device (e.g., a second access point). For example, the received signal may indicate an operating channel for or associated with the second computing device. For example, the operating channel for or associated with the second computing device may be a second operating channel, different from the operating channel for or associated with the computing device. For example, the computing device may listen on the reporting channel for a portion (e.g., second portion) of the reporting period. For example, the computing device may determine when to listen and when to send signals by using a mechanism called Clear Channel Assessment (CCA), where the computing device actively listens on the reporting channel before sending its signal, to ensure the reporting channel is clear, effectively following a listen before speaking approach to avoid signal collisions with other computing devices on the reporting channel. If the reporting channel is busy, the computing device waits for a short period before attempting to send its signal on the reporting channel again. For example, the computing device may listen for other computing devices (e.g., access points) reporting on the reporting channel. For example, the computing device may hear or receive the signal sent by the second computing device during the portion of the reporting period. The signal of the second computing device may be a beacon signal and may indicate or include one or more of the second operating channel for or associated with the second computing device, an identifier (e.g., MAC address, name, unique address, etc.) for the second computing device, a bandwidth utilization for the operating channel of the second computing device, a number of devices communicating on the operating channel of the second computing device, a signal-to-noise ratio for the operating channel of the second computing device, and/or an amount of interference on the operating channel of the second computing device. While the example of FIG. 14 describes only receiving one signal from one other computing device, this is for example purposes only as the number of other computing devices can be any amount and can result in the computing device receiving substantially similar signals as described above on the reporting channel that provide the same types of information as above from tens or hundreds of other computing devices.

The computing device may store the information (e.g., the device IDs, the operating channels, the bandwidth utilization, the SNR, the number of devices on a particular channel, and/or amount of interference) received from the signals of the other computing devices on the reporting channel during the reporting period in a storage device associated with the computing device. For example, the computing device may store the information in a file or record associated with the particular device ID of a respective other computing device from which the signal was received. For example, the computing device my subsequently use the information received during the reporting period from the other computing devices to determine which channel to switch to when changing operating channels at the computing device.

At 1440, the computing device may determine to change the operating channel for the computing device from a first operating channel to a third operating channel. For example, the third operating channel may be different from the first operating channel and may be the same or different from the second operating channel for the second computing device. For example, the computing device may determine to change the operating channel based on receiving the signal from the second computing device and/or one or more other computing device on the common reporting channel. For example, the computing device may determine to change the operating channel to the third operating channel based on the information contained in the signal. For example, the computing device may determine to change the operating channel to the third operating channel based on one or more of the second operating channel (or another operating channel) for or associated with the second computing device (or another computing device), a bandwidth utilization for the second operating channel of the second computing device (or another computing device), a number of devices communicating on the second operating channel of the second computing device (or another computing device), a signal-to-noise ratio for the second operating channel of the second computing device (or another computing device), and/or an amount of interference on the second operating channel of the second computing device (or another computing device). The computing device may then change its operating channel from the first operating channel to the third operating channel.

At the completion of the reporting period the reporting interval may begin again and the next communication period may begin for the computing device. The computing device may switch from the reporting channel to the third operating channel for the computing device. During this next communication period and the reporting interval, the computing device may send one or more beacon signals on the third operating channel, as well as listen for and communicate with devices on the third operating channel in the computing device's network. The process for the computing device may then continue with transitioning between the communication periods (on the third operating channel for the computing device) and the reporting periods (on the reporting channel) for as long as the computing device operates without a loss of power, a reset, or a change of location.

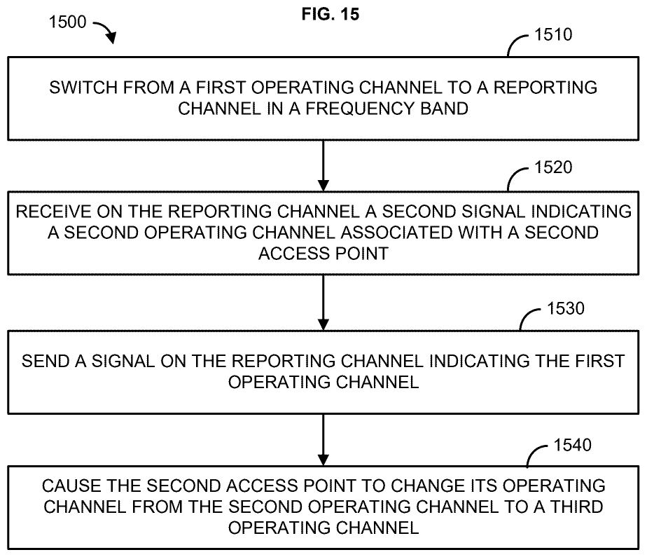

FIG. 15 is a flowchart illustrating an example method 1500 for communicating operating channel information on a reporting channel (e.g., a common reporting channel). The method 1500 may be completed by a computing device, such as any of the computing devices 102-110 of FIG. 1. For example, the computing device may be an access point, a gateway, or a router. For example, the computing device may be configured to wirelessly communicate via one or more wireless communication protocols, such as WI-FI, Bluetooth, Zigbee or the like. For example, the computing device may be configured to wirelessly communicate with one or more other devices (e.g., client devices, stations, etc.) on a network via an operating channel of a frequency band. For example, the frequency band may be one of a 5 gigahertz frequency band or a 6 gigahertz frequency band. For example, the operating channel for the computing device may be any channel of the frequency band other than the reporting channel. The reporting channel may be any channel on the frequency band. For example, the reporting channel may be the highest or lowest frequency channel on the frequency band. For example, the reporting channel may be channel 233 of the 6 gigahertz frequency band.

The computing device may determine a reporting interval and/or the start of the reporting interval for sending signals on the reporting channel. For example, the computing device may determine the reporting interval and/or the start of the reporting interval based on either of the methodologies described in FIGS. 5-6 above (e.g., sending the initial signal after not receiving other signals during a listening mode or receiving a signal from another computing device during the listening mode). For example, the computing device may determine the reporting periods for reporting (e.g., sending a signal and listening for signals from other computing devices) on the reporting channel based on the reporting interval.

For example, each reporting period may be separated in time from the next reporting period by the reporting interval. For example, following each reporting period, the computing device may switch from the reporting channel to the operating channel for that computing device and begin communicating with one or more devices (e.g., client devices, wireless network extenders, and/or other stations) on its specific network. For example, the computing device may be configured to communicate with the one or more devices on the operating channel of the computing device during a communication period. For example, the communication period may be equal to or less than the reporting interval. For example, the reporting interval may be a predetermined or pre-set amount of time. For example, the reporting interval may be 50 ms.

By determining the start of the reporting interval based on sending the initial signal or receiving the signal from the second computing device on the reporting channel, each of the computing devices within communication range will be generally aligned in the timing of their respective communication periods and reporting periods such that they will each be able to receive the signals from the other computing devices during the reporting period on the reporting channel. For example, the reporting interval may be the same for each of the computing devices that report and are within a communication range of the computing device.

For example, after sending the initial signal (FIG. 5) or receiving the initial signal (FIG. 6) during the listening period, the computing device may switch from the reporting channel to the operating channel for the computing device. During the communication period and the reporting interval, the computing device may send one or more beacon signals on the operating channel of the computing device as well as listen for and communicate with devices on the operating channel of the computing device in the computing device's network.

At 1510, the computing device may switch from the operating channel to the reporting channel in the frequency band. For example, the computing device may switch from the operating channel to the reporting channel based on the reporting interval expiring. For example, the computing device may switch from the operating channel to the reporting channel based on the communication period expiring. For example, the computing device may switch from the operating channel to the reporting channel at substantially the same time (e.g., within 5 ms of each other) that other computing devices switch from their respective operating channel to the reporting channel.

For example, the computing device may communicate with the one or more devices on the operating channel during the communication period and until the end of the reporting interval. Once the end of the reporting interval is reached (e.g., and/or the end of the communication period is reached), the reporting period begins and the computing device may switch from its operating channel to the reporting channel. For example, the reporting period may be a predetermined or pre-set amount of time. For example, the reporting period may be 10 ms or any other amount of time.

At 1520, the computing device may receive a signal on the reporting channel. For example, the received signal may be sent by a second computing device (e.g., a second access point). For example, the received signal may indicate an operating channel for or associated with the second computing device. For example, the operating channel for or associated with the second computing device may be a second operating channel, different from the operating channel for or associated with the computing device. For example, the computing device may listen on the reporting channel for a portion (e.g., second portion) of the reporting period. For example, the computing device may determine when to listen and when to send signals by using a mechanism called Clear Channel Assessment (CCA), where the computing device actively listens on the reporting channel before sending its signal, to ensure the reporting channel is clear, effectively following a listen before speaking approach to avoid signal collisions with other computing devices on the reporting channel. If the reporting channel is busy, the computing device waits for a short period before attempting to send its signal on the reporting channel again. For example, the computing device may listen for other computing devices (e.g., access points) reporting on the reporting channel. For example, the computing device may hear or receive the signal sent by the second computing device during the portion of the reporting period. The signal of the second computing device may be a beacon signal and may indicate or include one or more of the second operating channel for or associated with the second computing device, an identifier (e.g., MAC address, name, unique address, etc.) for the second computing device, a bandwidth utilization for the operating channel of the second computing device, a number of devices communicating on the operating channel of the second computing device, a signal-to-noise ratio for the operating channel of the second computing device, and/or an amount of interference on the operating channel of the second computing device. While the example of FIG. 14 describes only receiving one signal from one other computing device, this is for example purposes only as the number of other computing devices can be any amount and can result in the computing device receiving substantially similar signals as described above on the reporting channel that provide the same types of information as above from tens or hundreds of other computing devices.

The computing device may store the information (e.g., the device IDs, the operating channels, the bandwidth utilization, the SNR, the number of devices on a particular channel, and/or amount of interference) received from the signals of the other computing devices on the reporting channel during the reporting period in a storage device associated with the computing device. For example, the computing device may store the information in a file or record associated with the particular device ID of a respective other computing device from which the signal was received. For example, the computing device my subsequently use the information received during the reporting period from the other computing devices to determine which channel to switch to when changing operating channels at the computing device.

At 1530, the computing device may send a signal on the reporting channel of the frequency band. For example the signal may indicate the operating channel (e.g., the first operating channel) for the computing device. For example, the computing device may, during a portion of the reporting period, send a signal on the reporting channel. For example, the signal may be a beacon signal. For example, the signal may indicate or include one or more of the first operating channel for the computing device, an identifier for the computing device, a bandwidth utilization for the first operating channel of the computing device, a number of devices communicating on the first operating channel of the computing device, a signal-to-noise ratio for the first operating channel of the computing device, and/or an amount of interference on the first operating channel of the computing device.

At 1540, the computing device may cause the second computing device (e.g., the second access point) to change the operating channel for the second computing device from the second operating channel to a third operating channel. For example, the third operating channel may be different from the second operating channel and may be the same or different from the first operating channel for the computing device. For example, the computing device may cause the second computing device to change the operating channel based on sending the signal from the computing device on the common reporting channel. For example, the computing device may cause the second computing device to change the operating channel to the third operating channel based on the information contained in the signal sent by the computing device on the common reporting channel. For example, the computing device may cause the second computing device to change the operating channel to the third operating channel based on one or more of the first operating channel for or associated with the computing device, a bandwidth utilization for the first operating channel of the computing device, a number of devices communicating on the first operating channel of the computing device, a signal-to-noise ratio for the first operating channel of the computing device, and/or an amount of interference on the first operating channel of the computing device. The second computing device may then change its operating channel from the second operating channel to the third operating channel.

At the completion of the reporting period the reporting interval may begin again and the next communication period may begin for the computing device. The computing device may switch from the reporting channel to the first operating channel for the computing device. During this next communication period and the reporting interval, the computing device may send one or more beacon signals on the first operating channel, as well as listen for and communicate with devices on the first operating channel in the computing device's network. The process for the computing device may then continue with transitioning between the communication periods (on the first operating channel for the computing device) and the reporting periods (on the reporting channel) for as long as the computing device operates without a loss of power, a reset, or a change of location.

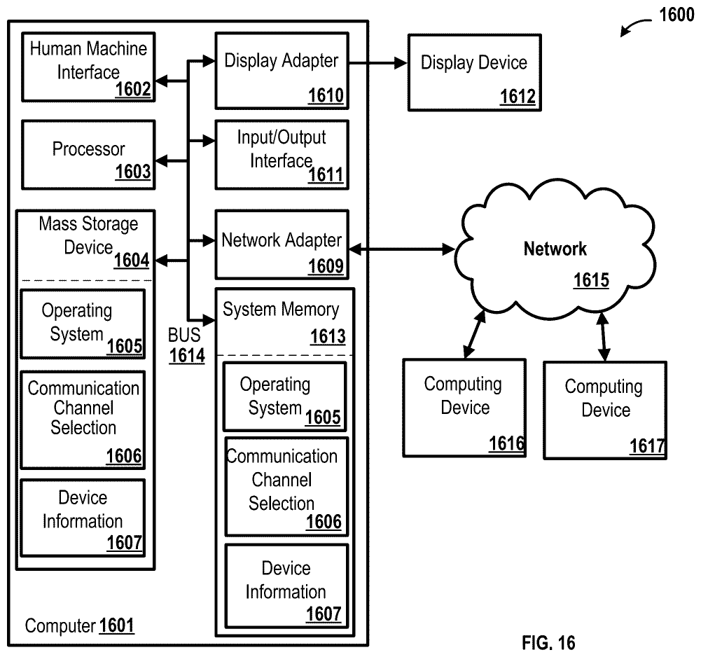

FIG. 16 shows a block diagram of an example system 1600 and computing device 1601 (e.g., computer) for communicating operating channel information on a reporting channel. Any device/component described herein (e.g., the computing devices 102-110 may be the computing device 1601 as shown in FIG. 16.

The computing device 1601 may include one or more processors 1603, a system memory 1613, and a bus 1614 that couples various components of the computing device 1601 including the one or more processors 1603 to the system memory 1613. In the case of multiple processors 1603, the computing device 1601 may utilize parallel computing.

The bus 1614 may include one or more of several possible types of bus structures, such as a memory bus, memory controller, a peripheral bus, an accelerated graphics port, and a processor or local bus using any of a variety of bus architectures.

The computing device 1601 may operate on and/or include a variety of computer-readable media (e.g., non-transitory). Computer-readable media may be any available media that is accessible by the computing device 1601 and includes, non-transitory, volatile and/or non-volatile media, removable and non-removable media. The system memory 1613 has computer-readable media in the form of volatile memory, such as random access memory (RAM), and/or non-volatile memory, such as read-only memory (ROM). The system memory 1613 may store data such as device information 1607 and/or program modules such as an operating system 1605 and a communication channel selection system 1606 that are accessible to and/or are operated on by the one or more processors 1603. The device information 1607 may include identifiers for other computing devices, a bandwidth utilization for the operating channel of other computing devices, a number of devices communicating on the operating channel of other computing devices, a signal-to-noise ratio for the operating channel of other computing devices, and/or an amount of interference on the operating channel associated with other computing devices, such as the computing devices 1616, 1617.

The computing device 1601 may also include other removable/non-removable, volatile/non-volatile computer storage media. The mass storage device 1604 may provide non-volatile storage of computer code, computer-readable instructions, data structures, program modules, and other data for the computing device 1601. The mass storage device 1604 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules may be stored on the mass storage device 1604. For example, an operating system 1605 and the communication channel selection system 1606 may be stored on the mass storage device 1604. Device information 1607 may also be stored on the mass storage device 1604. The device information 1607 may be stored in any of one or more databases known in the art. The databases may be centralized or distributed across multiple locations within the network 1615.

A user may enter commands and information into the computing device 1601 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 1603 via a human machine interface 1602 that is coupled to the bus 1614, but may be connected by other interface and bus structures, such as a parallel port, game port, an IEEE 1394 Port (also known as a Firewire port), a serial port, network adapter 1609, and/or a universal serial bus (USB).

A display device 1612 may also be connected to the bus 1614 via an interface, such as a display adapter 1610. It is contemplated that the computing device 1601 may have more than one display adapter 1610 and the computing device 1601 may have more than one display device 1612. A display device 1612 may be a monitor, an LCD (Liquid Crystal Display), light-emitting diode (LED) display, television, smart lens, smart glass, and/or a projector. In addition to the display device 1612, other output peripheral devices may comprise components such as speakers (not shown) and a printer (not shown) which may be connected to the computing device 1601 via Input/Output Interface 1611. Any step and/or result of the methods may be output (or caused to be output) in any form to an output device. Such output may be any form of visual representation, including, but not limited to, textual, graphical, animation, audio, tactile, and the like. The display device 1612 and computing device 1601 may be part of one device, or separate devices.

The computing device 1601 may operate in a networked environment using logical connections to one or more remote computing devices 1616, 1617. The remote computing devices 1616, 1617 may correspond to any one of the devices 102-110 of FIG. 1 and may comprise one or more of a access point, router, gateway, mesh extender, subordinate device, augmented reality device, virtual reality device, personal computer, computing station (e.g., workstation), portable computer (e.g., laptop, mobile phone, smart phone tablet computer), smart television, set-top-box, smart device (e.g., smartphone, smartwatch, activity tracker, smart apparel, smart accessory), an IoT device, a thermostat, a home appliance or other common network nodes, and so on. Logical connections between the computing device 1601 and the computing devices 1616, 1617 may be made via one or more of a local network devices, a remote network device, and/or a network 1615, such as a local area network (LAN) and/or a general wide area network (WAN). Such network connections with the computing device 1601 may be through a network adapter 1609. The network adapter 1609 may be implemented in both wired and wireless environments. Such networking environments are conventional and commonplace in dwellings, offices, enterprise-wide computer networks, intranets, and the Internet.

Application programs and other executable program components such as the operating system 1605 and the communication channel selection system 1606 are shown herein as discrete blocks, although it is recognized that such programs and components may reside at various times in different storage components of the computing device 1601, and are executed by the one or more processors 1603 of the computing device 1601. An implementation of the communication channel selection system 1606 may be stored on or sent across some form of computer-readable media. Any of the disclosed methods may be performed by processor-executable instructions embodied on computer-readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
switching, by a computing device, from an operating channel to a reporting channel of a frequency band;
sending a first signal on the reporting channel indicating the operating channel for the computing device; and
determining, based on sending the first signal, a reporting interval for sending subsequent signals on the reporting channel.

2. The method of claim 1, wherein the frequency band is a 6 gigahertz frequency band and wherein the reporting channel is channel 233 of the 6 gigahertz frequency band.

3. The method of claim 1, further comprising:
sending, based on switching from the reporting channel to the operating channel, at least one beacon signal on the operating channel; and
sending, during a next reporting interval, a second signal on the reporting channel indicating the operating channel for the access point.

4. The method of claim 3, further comprising receiving, from a second computing device, a signal indicating an operating channel associated with the second computing device.

5. The method of claim 1, further comprising listening for a signal from a second computing device on the reporting channel, wherein sending the first signal is based on not receiving the signal from the second computing device.

6. The method of claim 1, further comprising:
receiving, from a second computing device, a signal indicating the operating channel associated with the second computing device, wherein the reporting interval for sending subsequent signals on the reporting channel is further determined based on receiving the signal from the second computing device.

7. The method of claim 1, wherein the first signal further comprises one or more of a device identifier associated with the computing device, bandwidth utilization for the operating channel, a number of devices communicating on the operating channel, or an amount of interference on the operating channel.

8. The method of claim 1, further comprising:
receiving, from a plurality of other computing devices, a plurality of signals on the reporting channel; and
determining, based on the plurality of signals, one or more other operating channels associated with each of the plurality of other computing devices.

9. A method comprising:
switching, by a computing device, from an operating channel to a reporting channel of a frequency band;
receiving, from a second computing device, a signal on the reporting channel, wherein the signal indicates a second operating channel associated with the second computing device; and
determining, based on the received signal, a reporting interval for the computing device sending subsequent signals on the reporting channel.

10. The method of claim 9, further comprising sending a first signal on the reporting channel indicating the operating channel for the computing device.

11. The method of claim 9, wherein the frequency band is a 6 gigahertz frequency band and wherein the reporting channel is channel 233 of the 6 gigahertz frequency band.

12. The method of claim 9, further comprising:
sending, based on switching from the reporting channel to the operating channel, at least one beacon signal on the operating channel; and
sending, during a next reporting interval, a first signal on the reporting channel indicating the operating channel for the computing device.

13. The method of claim 9, further comprising:
switching, based on the reporting interval, from the operating channel to the reporting channel;
sending the first signal on the reporting channel indicating the operating channel for the computing device; and
receiving, from one or more other computing devices, one or more other signals indicating an operating channel associated with a respective computing device of the one or more other computing devices.

14. The method of claim 9, further comprising:
switching from the reporting channel to the operating channel; and
sending one or more beacon signals on the operating channel.

15. The method of claim 9, wherein the received signal further comprises one or more of a device identifier associated with the second computing device, bandwidth utilization for the second operating channel, a number of devices communicating on the second operating channel, or an amount of interference on the second operating channel.

16. A method comprising:
switching, by a computing device, from an operating channel to a reporting channel of a frequency band;
sending a first signal on the reporting channel, wherein the first signal indicates the operating channel for the computing device; and
receiving, from a second computing device, a second signal on the reporting channel, wherein the second signal indicates a second operating channel associated with the second computing device.

17. The method of claim 16, wherein the frequency band is a 6 gigahertz frequency band and wherein the reporting channel is channel 233 of the 6 gigahertz frequency band.

18. The method of claim 16, further comprising:
switching from the reporting channel to the operating channel; and
sending one or more beacon signals on the operating channel.

19. The method of claim 18, further comprising:
switching, based on a reporting interval, from the operating channel to the reporting channel; and
sending a third signal on the reporting channel, wherein the third signal indicates the operating channel.

20. The method of claim 16, wherein the first signal further comprises one or more of a device identifier associated with the computing device, bandwidth utilization for the operating channel, a number of devices communicating on the operating channel, or an amount of interference on the operating channel.
